(19) United States
(12) Patent Application Publication
(10) Pub. No.: US 2007/0162748 A1
(43) Pub. Date: Jul. 12, 2007

(54) Apparatus for Encrypted Communication on Network

(76) Inventors: Masataka Okayama, Fujisawa (JP); Akira Tanaka, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/620,185

(22) Filed: Jan. 5, 2007

(30) Foreign Application Priority Data
Jan. 6, 2006 (JP) 2006-001309

(51) Int. Cl. H04L 9/00

(52) U.S. Cl. 713/165

(57) ABSTRACT

An adapter device connected to a network for encrypted communication includes: a connection management unit for performing connection control for connection with a first communication device connected to a network via an access management server or a network outside the network; a storage unit for storing connection policy information for a first communication device and a second communication device directly connected to the adapter device; a communication control unit for judging a method of communication with the first communication device and the second communication device by using the connection policy information; and an encrypted communication unit for encrypting/decrypting communication data to/from the first communication device and the second communication device if the communication control unit makes a judgment of encrypted communication.

### INCORPORATION BY REFERENCE

The present application claims priority from Japanese application JP2006-001309 filed on Jan. 6, 2006, the content of which is hereby incorporated by reference into this application.

### BACKGROUND OF THE INVENTION

The present invention relates to, for example, a technique for performing a secret communication with an in-home device by accessing from an outside-home device, a home network to which in-home devices such as an HDD recorder and an illumination device are connected or an encrypted communication with a PC and a printer and a Web server of a network in an enterprise.

Recently, home AV devices such as a digital TV and a DVD/HDD recorder, home electric devices such as an air conditioner and an illumination device, and home facility devices such as an electric door lock and various sensors are connected to a network. That is, a home network connecting these devices is being developed. Furthermore, it is expected that the network service using these devices will be spread.

However, when these devices are connected to the network, it becomes easy to access the devices connected to the home network from an outside-home device, which requires a countermeasure for an unauthorized access from an external device and an access by impersonation. Especially, devices used for the home security service such as an electric door lock and various sensors may cause a serious accident when accessed in an unauthorized way from an outside-home device. Accordingly, it is very important to make a countermeasure for these unauthorized accesses.

On the other hand, enterprises also have a problem of information leak which is caused intentionally or by careless mistake and a countermeasure for it should be established as soon as possible.

JP-A-2002-77274 discloses a method for authenticating an outside-home device by an access server device connected with the outside-home device via the Internet so that a home gateway device arranged at the entrance of the home network communicates only with the aforementioned access server device, thereby preventing an unauthorized access from the outside-home device.

Moreover, JP-A-2003-158553 discloses an IP telephone device performing peer-to-peer communication without passing through a special server (gate keeper) considering the load on the server.

### SUMMARY OF THE INVENTION

However, in the method disclosed in JP-A-2002-77274, when data communication is performed between an authorized outside-home device and a device (in-home device) connected to the home network, the aforementioned data inevitably passes through the access server device and the home gateway device and the load on these devices increases when a concentration of communication data occurs. That is, no consideration is taken for a large-capacity data communication such as increase of the in-home devices and the video data.

On the other hand, the method disclosed in JP-A-2003-158553 solves the problem of the high load of the server and the like since it does not require a special server (gate keeper). However, the method takes no consideration on an unauthorized access. In order to prevent an unauthorized access, an in-home device should authenticate an outside-home device. In this case, if the number of outside-home devices to be communicated with the in-home device increases, the authentication function of each of the in-home devices should be updated.

Moreover, in an in-home device, an application unique to the device is normally mounted. When accessing these in-home devices from an authorized outside-home device by peer-to-peer communication, a user using the authorized outside-home device should know that what kind of application is mounted on each of the in-home devices.

Moreover, in the aforementioned known examples, an authentication function or the like should be mounted on the in-home device. For example, it is difficult to mount the authentication function on in-home devices having a low processing ability such as an air conditioner and a lamp.

To cope with this, there is provided an encrypted communication technique reducing the load on the server and having a high safety.

For example, the home gateway device (adapter device) includes a connection management unit for managing information en bloc on the in-home devices (in-home communication devices), deciding an in-home device to be connected to the outside-home device according to connection instruction information from the outside-home device (outside-home communication device) transmitted via the access management server and the information on the in-home device, and transmitting information for performing peer-to-peer communication with the outside-home device, to the in-home device. Furthermore, the in-home device has a peer-to-peer communication unit for performing communication with the outside-home device according to the information transmitted from the connection management unit. Since control from outside-home to the in-home device is performed by peer-to-peer communication, it is possible to reduce the load on the server and assure a high safety.

Moreover, the home gateway device includes a device authentication unit. The device authentication unit is configured to check validity of the outside-home device. Accordingly, even in the peer-to-peer communication, it is possible to prevent an unauthorized access by a third party and assure a high safety.

Moreover, the home gateway device includes a communication processing unit so that an outside-home device and an in-home device can perform peer-to-peer communication via the home gateway device. In the communication between the outside-home device and the in-home device directly connected to the home gateway device, secret communication is performed between the outside-home device and the home gateway device. Thus, it is possible to assure a high safety even in an in-home device having a low processing ability.

With the aforementioned configuration, it is possible to reduce the load on the server and assures a high safety for communication between the devices.

The other objects, features, and advantages of the present invention will become clear from the description given below with reference to the attached drawings.

### BRIEF DESCRIPTION OF THE DRAWINGS

FIG. 1 shows an outline of a configuration example of an in-home and outside-home communication system.

FIG. 2 shows a hardware configuration example of an information processing device.

FIG. 3 shows a data structure example of a service information database.

FIG. 4 shows a device access/registration processing example.

FIG. 5 shows a service registration processing example.

FIG. 6 shows a service execution start processing example.

FIG. 7 shows a service data transfer processing example.

FIG. 8 shows a service execution end processing example.

FIG. 9 shows a service delete processing example.

FIG. 10 shows a device access delete processing example.

FIG. 11 shows a data structure example of a port information database.

FIG. 12 shows a data structure example of a service information database.

FIG. 13 shows a service execution start processing example.

FIG. 14 shows a service execution end processing example.

FIG. 15 shows an outline of a configuration example of an in-home and outside-home communication system.

FIG. 16 shows an outline of another configuration example of an in-home and outside-home communication system.

FIG. 17 shows a hardware configuration example of a home gateway device.

FIG. 18 shows a function configuration example of the home gateway device.

FIG. 19 shows a function configuration example of an in-home communication device.

FIG. 20 shows a data structure example of a connection policy database.

FIG. 21 shows a device access registration processing example.

FIG. 22 shows a service execution start processing example.

FIG. 23 shows a service data transfer processing example.

FIG. 24 shows a service execution end processing example.

FIG. 25 shows a service delete processing example.

FIG. 26 shows a hardware configuration example of the home gateway device.

FIG. 27 shows a device access registration processing example.

FIG. 28 shows an outline of a configuration example of another embodiment (in-enterprise LAN system).

### DESCRIPTION OF THE EMBODIMENTS

Description will now be directed to embodiments of the present invention with reference to the attached drawings.

### Embodiment 1

In this embodiment, explanation will be given on a safe accessing an in-home system (in-home devices connected to a home network) from an outside-home device. However, the techniques of the present invention are not limited to an in-home system. The in-home system may be replaced by an in-company LAN system and the outside-home system may be replaced by an external-to-company device (device operated by an employee outside the company).

It should be noted that for simplifying the explanation, the adapter device is expressed as a home gateway device. However, when the present invention is applied to an in-company LAN system, it is more preferable that the adapter device be expressed as it is or a secure access gateway device.

First, explanation will be given on a configuration of the in-home/outside-home communication system according to the present embodiment.

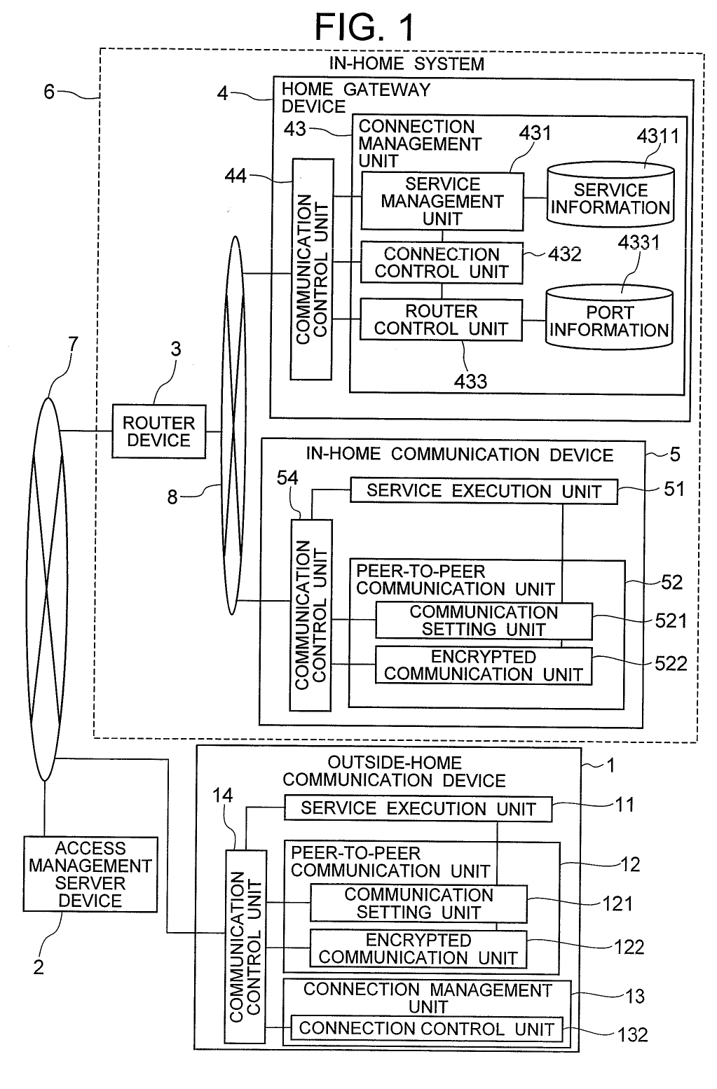

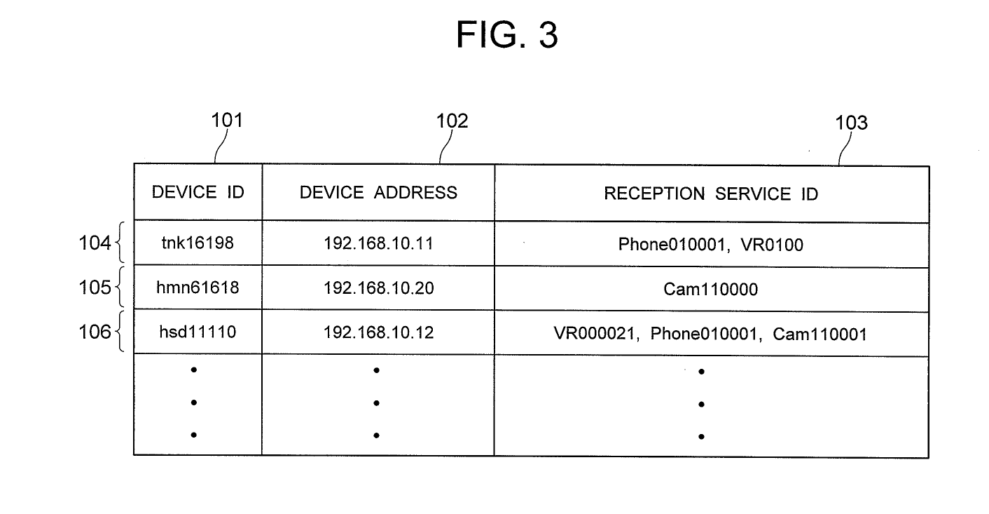

As shown in FIG. 1, the in-home/outside-home communication system according to the present embodiment includes an outside-home communication device 1 connected via a communication medium 7, an access management server device 2, and an in-home system 6. The in-home system 6 has a router device 3 connected to the communication medium 7, a home gateway device 4, and an in-home communication device 5. The respective devices 3 to 5 are connected via an in-home communication medium 8. The devices included in the in-home/outside-home communication system shown in FIG. 1 (outside-home communication device 1, access management server device 2, router device 3, home gateway device 4, and in-home communication device 5) can be implemented by an information processing device having a normal hardware configuration capable of executing software. More specifically, as shown in FIG. 3, each of these information processing devices includes a CPU (operation processing device) 91, a main storage 92, a communication control unit 93, an external storage unit 94, an input unit 95, and an output unit 96. Each of the units is connected to one another via a bus 97 so that necessary information can be delivered between the respective units.

The CPU 91 performs a predetermined operation by a program stored in advance in the main storage 92 and the external storage unit 94.

The main storage 92 functions as a work area and constitutes a means for storing a necessary program. For example, it is realized by a RAM for the former and by a ROM for the latter.

The communication control unit 93 is a means for delivering information (data) to/from devices connected to the same communication medium via various communication media and may be realized, for example, by a modem, a network adapter, a radio transmission/reception device.

The external storage unit 94 is a means for storing a program for controlling operation of the information processing device and accumulating a content delivered via the communication medium. For example, it is realized by a hard disk (HDD), an optical disk, and the like.

The input unit 95 is a means for inputting necessary instructions and information to the information processing device by a device user and may be realized, for example, by a remote controller used by a TV receiver, a keyboard and a mouse used by a PC, and the like.

The output unit 96 is a means for outputting/displaying a content and information in response to the operation of the device user and may be realized by a Braun tube, a CRT, a liquid crystal display, a PDP, a projector, a speaker, a headphone, and the like.

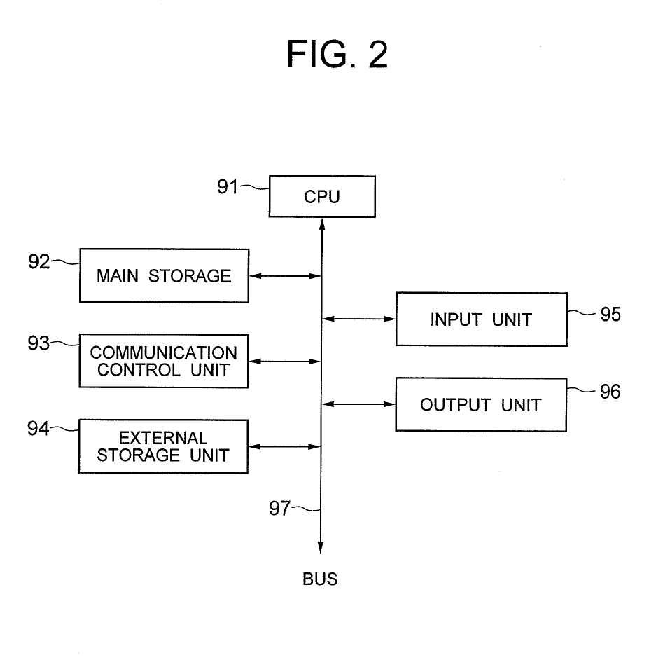

It should be noted that the hardware configuration of the information processing device shown in FIG. 2 is only an example and the hardware configuration of the devices 1 to 5 may be different from these. For example, the output unit 96 may be realized by a device (such as a television) different from the information processing device. In this case, the information processing device separately includes a television signal generation device such as a D/A converter and the device is connected to the output unit 6 by an AV cable or a coaxial cable. Moreover, when there are means not directly related to input/output of data and programs among the means of constituting the information processing device, the means may not be included. For example, when the information processing device does not require data input or output during execution, the input unit 95 and the output unit 96 may not be included in the configuration.

Moreover, the in-home system 6 included in the in-home/outside-home communication system shown in FIG. 1 is a system which may be installed in a general home such as a stand-alone house or in an apartment house.

Moreover, the communication medium 7 included in the in-home/outside-home communication system shown in FIG. 1 is a cable medium formed by an optical line, CATV, a telephone line, or the like, or a public communication network formed by using a radio medium, or dedicated communication network. The communication medium 7 allows data to be passed/received or exchanged according to a predetermined protocol between devices connected to the communication medium 7.

Moreover, the communication medium 8 is a cable medium formed by a communication cable, a power line, an exchange telephone line, and the like or a LAN (local area network) in the in-home system 6 formed by using a radio medium and can pass/receive or exchange data between devices connected to the communication medium 8 according to a predetermined communication protocol. Moreover, by relaying repeating data via the router device 4 connected to both of the communication medium 8 and the communication medium 7, it is possible to transparently pass and receive data between the decides connected to the communication medium 8 and the devices connected by the communication medium 7 according to a predetermined protocol.

It should be noted that generally the outside-home communication network such as the communication medium 7 and the in-home LAN such as the communication medium 8 have different address (IP address) systems as information for identifying a communication device. The former is often an address (global address) uniquely allocated in the whole world and the latter is an address (private address) valid only within the LAN. As the relay method (address conversion method) for relaying or repeating between the networks having different address systems, the NAT (Network Address Translation) is known.

Next, explanation will be given on functions and database configuration realized by execution of software by the respective devices 1 to 5 included in the in-home/outside-home communication system shown in FIG. 1.

The outside-home communication device 1 is an information processing device connected to the in-home communication device 5 included in the in-home system 6 for executing various services linked with the in-home communication device 5 (such as recording reservation service and a recorded video transfer service via a remote controller connected to an in-home communication device which is a video recorder, power ON/OFF service and temperature adjustment service connected to an in-home communication device which is an air conditioner, and a camera accumulated image viewing service connected to an in-home communication device which is a security camera). As shown in FIG. 1, the outside-home communication device 1 includes a service execution unit 11, a peer-to-peer communication unit 12, a connection management unit 13, and a communication control unit 14. The peer-to-peer communication unit 12 has a communication setting unit 121 and an encrypted communication unit 122. Moreover, the connection management unit 13 has a connection control unit 132.

The service execution unit 11 has the function of executing the aforementioned respective services linked with the in-home communication device 5 included in the in-home system 6. The service execution unit 11 executes the services linked with the in-home communication device 5 by using the peer-to-peer communication unit 12 for making connection with the in-home communication device 5 for executing data transfer.

It should be noted that in the system configuration shown in FIG. 1, the outside-home communication device 1 includes only one service execution unit 11 but it may include a plurality of service execution units. In the latter case, the outside-home communication device 1 may be linked with each of the in-home communication devices separately for executing service or may be linked with a single in-home communication device for executing a plurality of services. The plurality of services may be executed simultaneously or selectively.

The peer-to-peer communication unit 12 has a function of calling the connection control unit 13 by the information transmitted from the service execution unit 11, acquiring address information (IP address, port number, etc.) required for peer-to-peer data communication with the in-home communication device 5, setting a data communication connection with the in-home communication device 5 according to the address information, and setting encryption information required for encrypted communication in the data communication with the in-home communication device 5 by the information transmitted from the connection control unit 13.

The communication setting unit 121 has a function of setting address information (IP address, port number, etc.) required for peer-to-peer data communication with an external device (in-home communication device) via the communication control unit 14 and a function of setting encryption information (encryption key information, etc.) required for decryption of the communication data in the peer-to-peer encrypted communication.

The encrypted communication unit 122 has a function of decrypting the data (data transfer from the in-home communication device) received via the communication control device 14, by using the encrypted communication information set by the information transmitted from the communication setting unit 121 and a function of encrypting the transmission data (data transfer to the in-home communication device) by using the encrypted communication information and transmitting it via the communication control unit 14.

The connection management unit 13 has a function of transmitting service connection instruction information to the in-home communication device 5 via the access management server device 2 by the information transmitted from the peer-to-peer communication unit 12 and acquiring address information required for peer-to-peer data communication from the in-home communication device 5. The connection control unit 132 has a function of making connection with the access management server device 2 via the communication control unit 14, a function of transmitting the service connection instruction information for the in-home communication device 5 to the access management server device 2, and a function of acquiring address information required for data communication with the in-home communication device 5 from the access management server 2.

The communication control unit 14 has a function of generating, interpreting, and communicating a message according to the communication protocol so that the peer-to-peer communication unit 12, the connection management unit 13, and functional units included in these units (communication setting unit 121, encrypted communication unit 122, connection control unit 132) communicate with the devices connected to the communication medium 7 (access management server device 2, in-home system 6).

The access management server device 2 is an information processing device which has a relay or repeating function of receiving connection instruction information to be transmitted when the outside-home communication device 1 makes a service connection to the in-home communication device 5, searching the home gateway device 4 included in the in-home system 6 including the in-home communication device 5, and transmitting the connection instruction information to the home gateway device 4.

The access management server device 2 includes a communication control unit for performing data transfer according to the communication protocol, an access authentication unit for authenticating the validity of a connection device (outside-home communication device 1, home gateway device 4), an access management unit for managing the connection information on the connection device, and an access relay unit for searching a corresponding home gateway device 4 according to the connection instruction information from the outside-home communication device 1 and reporting the connection instruction information. Furthermore, the external storage unit of the access management server device 2 contains an authentication information management database containing authentication information on the authorized user of the in-home/outside-home communication system and a connection management database containing connection information (device identifier, IP address, port number, etc.) on the connection device.

With this functional configuration, firstly, the access authentication unit authenticates the connection between the outside-home communication device 1 and the home gateway device 4. After this, the communication control unit acquires the connection instruction information from the outside-home communication device 1. Then, the access relay unit instructs the access management unit to search connection information of the home gateway device 4 as the connection destination from the access management database and instructs the communication control unit to transfer the connection instruction information to the home gateway device 4 using the connection information. It should be noted that the communication protocol of the connection instruction information may be the SIP (Session Initiation Protocol) used in the IP telephone service which cal also be used in the access management server device 2.

The router device 3 is an information processing device having a function of making a connection to the communication medium 7 and the communication medium 8 and relaying or rejecting communication between devices connected to different communication media such as the outside-home communication device 1 connected to the communication medium 7 and the in-home communication device 4 connected to the communication medium 8.

The router device 3 includes an external communication control unit for performing data transfer an outside-home device (outside-home communication device 1) connected to the communication medium 7 according to the communication protocol, a port conversion unit for relaying communication information from the outside-home device connected to the communication medium 7 to an in-home device (in-home communication device 5) connected to the communication medium 8 (or performing the reverse processing), a port conversion control unit for controlling the port conversion setting referenced by the port conversion unit according to a request from the in-home device connected to the communication medium 8, and an internal communication control unit for performing data transfer to the in-home device connected to the communication medium 8 according to the communication protocol.

It should be noted that the relay or repeating method in the port conversion unit may be the aforementioned NAT. Moreover, the port conversion setting control method in the port conversion control unit may be the known control method defined by UPnP IGD (Universal Plug and Play Internet Gateway Device), which can also be applied to the router 3.

The home gateway device 4 is an information processing device for deciding an in-home communication device 5 to be connected to the outside-home communication device 1 based on the connection instruction information from the outside-home communication device 1 via the access management server device 2 and information on the in-home communication device 1, executing settings required for peer-to-peer communication between the both devices, and transmitting address information and the like required for the peer-to-peer communication to the both devices. As shown in FIG. 1, the home gateway device 4 has a connection management unit 43 and a communication control unit 44. The connection management unit 43 includes a service management unit 431, a connection control unit 432, and a router control unit 433. Furthermore, the home gateway device 4 has an external storage unit containing service information database 4311 and a port information database 4331.

The connection management unit 43 has a function of managing service information en bloc which the in-home communication device can receive by the information transmitted from the peer-to-peer communication unit 12 of the in-home communication device 5 included in the in-home system 6, deciding an in-home device 5 to be connected according to the connection instruction information and the management information transmitted from the outside-home communication device 1 via the access management server device 2, controlling the port conversion of the router device 3 so as to enable reception of data communication from the outside-home communication device 1, transmitting information required for data communication connection between the outside-home communication device 1 and the in-home communication device 5 to the outside-home communication device 5, and transmitting it to the outside-home communication device 1 via the access management server device 2.

The service management unit 431 has a function of acquiring information of the service which can be received by the in-home communication device 5 and managing the information along with an identifier and its address information of the in-home communication device 5 by using a service information database 4311 and a function of deciding whether connection is enabled or disabled and deciding an in-home communication device 5 to be connected from the connection instruction information transmitted from the outside-home communication device 1 and the information managed by the service information database 4311.

The connection control unit 432 has a function of making a connection with the access management server device 2 via the communication control unit 44, a function of receiving the service connection instruction information from the outside-home communication device 1 from the access management server device 2, and a function of transmitting address information required for data communication with the outside-home communication device 1 to the access management server device 2.

The router control unit 433 has a function of transmitting port conversion setting information (external port number, internal port number, etc.) for relaying the data communication from the outside-home communication device 1 to the in-home communication device 5 to the port conversion control unit of the router device 3 so as to set the port conversion and a function of managing the port conversion setting information along with information on the in-home communication device (device information and service information) which is using the port conversion by using the port information database 4331.

The communication control unit 44 has a function of generating, interpreting, and communicating a message according to a communication protocol so that the connection management unit 43 and the function units contained therein (service management unit 431, connection control unit 432, router control unit 433) can communicate with the device (access management server device 2) connected to the communication medium 7 via the devices connected to the communication medium 8 (router device 3, in-home communication device 5) and the router device 3.

The service information database 4311 is a database for managing information services en bloc which can be received by the in-home communication device 5 connected to the in-home system 3. As shown in FIG. 3, the service information database 4311 registers, for each in-home communication device connected to the in-home system 3, a device ID 101 which is an identifier of the in-home communication device, a device address 102 which is address information (IP address, MAC address, etc.) required for identifying the in-home communication device on the in-home network (communication medium 8), and a reception service ID 103 which is an identifier of a service which can be executed (linked operation) in the in-home communication device from the external device (outside-home communication device). Here, the reception service ID 103 can contain a plurality of information pieces.

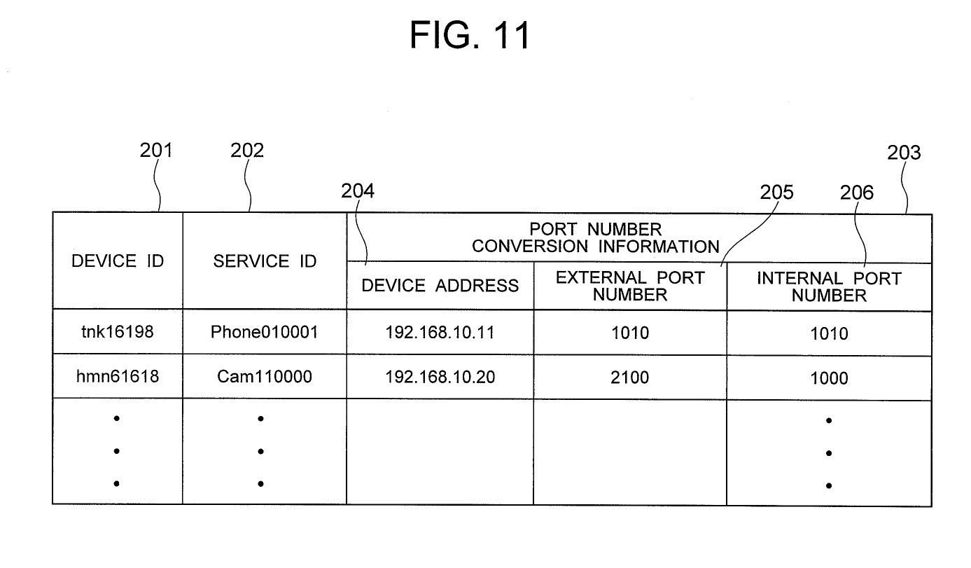

The port information database 4331 is a database for managing information on the port number conversion setting corresponding to the in-home communication device 5 connected to the in-home system 3. As shown in FIG. 11, the port information database 4331 registers a device ID 201 which is an identifier of the in-home communication device, a reception service ID 202 of the service on the in-home communication device for executing data communication with the outside-home communication device by using the port number conversion, and port number conversion information 203 set by controlling the router device 3. The port number conversion information includes a device address 204 of the in-home communication device corresponding to the port conversion, an external port number 205 of the port conversion, and an internal port number 206.

The in-home communication device 5 is an information processing device having a function of executing various services (such as a remote-controlled reservation for video recording from outside-home) by making a connection and linkage by the peer-to-peer communication with the outside-home communication device 1. As shown in FIG. 1, the in-home communication device 5 includes a service execution unit 51, a peer-to-peer communication unit 52, and a communication control unit 54. The peer-to-peer communication unit 52 includes a communication setting unit 521 and an encrypted communication unit 522.

The service execution unit 51 has a function of executing various services linked with the outside-home communication device 1. The service execution unit 51 executes data transfer by making a connection with the in-home communication device 5 by using the peer-to-peer communication unit 52, thereby executing a service linked with the outside-home communication device 1. It should be noted that in the system configuration shown in FIG. 1, the in-home communication device 5 includes only one service execution unit 51 but it may include a plurality of service execution units. In the latter case, the in-home communication device 5 can simultaneously or selectively realize a service by linking with each of the outside-home communication devices or executing a plurality of services by linking with a single outside-home communication device.

The peer-to-peer communication unit 52 has a function of setting a data communication connection with the outside-home communication device 1 by information transmitted from the connection management unit 41 of the home gateway device 4 and setting encryption information required for encrypted communication in the data communication with the in-home communication device 5 by using that information. The communication setting unit 521 has a function of setting address information (IP address, port number, etc.) required for peer-to-peer data communication with an external device (outside-home communication device 1) via the communication control unit 54 and a function of setting encrypted information (including encryption method and encryption key and so on) required for decryption of encryption of communication data in peer-to-peer encrypted communication.

The encrypted communication unit 522 has a function of decrypting the data received via the communication control unit 54 (data transfer from the outside-home communication device) by using the encrypted communication information set by the information transmitted from the communication setting unit 521 and a function of encrypting the transmission data (data transfer to the outside-home communication device) by using the encrypted communication information before transmitting it via the communication control unit 54.

The communication control unit 54 has a function of generating, interpreting, and communicating a message according to the communication protocol so that the peer-to-peer communication unit 12 and functional units included therein (communication setting unit 121, encrypted communication unit 122) can communicate with the devices (outside-home communication device 1, access management server device 2) connected to the communication medium 7 via the devices (router device 3, home gateway device 4) connected to the communication medium 8 and the router device 3.

Next, explanation will be given on the outline of a service execution process on the in-home communication device by an authorized outside-home communication device executed in the in-home/outside-home communication system shown in FIG. 1.

Here, an example given below is such that the outside-home communication device 1 calls a service operated by the in-home communication device 5 existing in the in-home system 6 and acquires the processing result.

The service execution process is realized by successively executing the following steps: a device access start process (S1000) performed before execution of linked service between devices, by the outside-home communication device 1 and the home gateway device 4 included in the in-home system 6 being connected to the access management server device 2 so as to register address information on the device required for data transfer of the connection instruction information between devices and perform device authentication; a service registration process (S2000) for registering information required by the in-home communication device 5 for identifying a reception service in the home gateway device 4; a service execution start process (S3000) performed by the outside-home communication device 1 by transmitting the connection instruction information to the home gateway device 4 via the access management server device 2 so as to establish a peer-to-peer communication between the outside-home communication device 1 and the in-home communication device 5; a service data transfer process (S4000) for performing a peer-to-peer communication between the outside-home communication device 1 and the in-home communication device 5 upon service execution; a service execution end process (S5000) performed by the outside-home communication device 1 by transmitting connection end instruction information to the home gateway device 4 via the access management server device 2 so as to terminate execution of the linked service between the outside-home communication device 1 and the in-home communication device 5; a service delete process (S6000) performed by the in-home communication device 5 by reporting delete of the reception service to the home gateway device 4; and a device access end process (S7000) (for disconnecting the home gateway device 4 from the access management server device 2) so that the home gateway device 4 will not receive a notification from the access management server device 2.

Here, the service execution process should execute only the steps S3000, S4000, and S5000. The steps S1000 and S2000 are pre-processes for service execution upon device start and steps S6000 and S7000 are post-processes for service execution upon device termination.

Hereinafter, explanation will be given on details of these steps (S1000 to S7000).

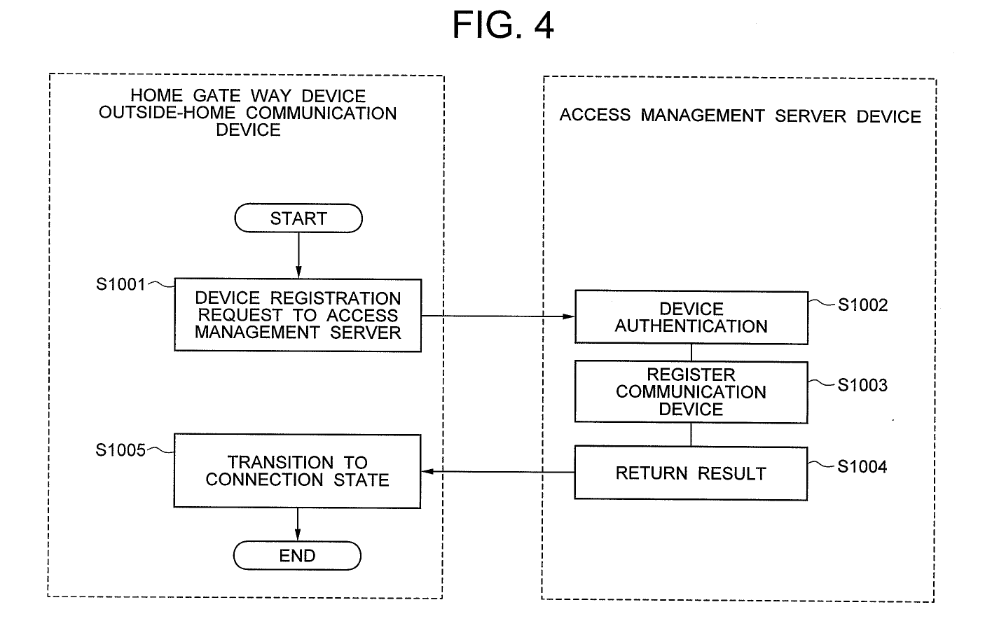

FIG. 4 is a flowchart of processes executed in the device access start process (S1000).

Upon initialization such as device start, the connection control unit 432 of the home gateway device 4 included in the in-home system 6 transmits device registration request information containing address information and authentication information from the communication control unit 44 via the communication medium 8, the router device 3, and the communication medium 7 to the access management server device 2 (S1001). The address information used here includes an IP address and a port number used by the home gateway device 4 to receive a report or notification from the access management server device 2. Moreover, the authentication information may be, for example, a unique user ID for identifying a user of the home gateway device 4, a combination of the user ID and a password, a unique device ID capable of identifying the home gateway device 4, and a device unique certificate based on PKI (Public Key Infrastructure).

In the access management server device 2, first, the authentication information management database searches, i.e., authenticates authentication information matched with the authentication information contained in the device registration request information from the home gateway device 4. If no authentication information is matched, i.e., if the authentication has failed, the access management server device 2 returns information indicating the connection rejection to the home gateway device 4. When the home gateway device 4 receives the connection rejection information, it displays a message that connection with the access management server device 2 has failed on an output unit and terminates the device access start process.

On the other hand, if any authentication information is matched with the authentication information contained in the device registration request information, i.e., if the authentication is successful, the address information contained in the device registration request information is registered in the connection management database (S1003) and information indicating the successful connection is returned to the home gateway device 4 (S1004). The connection control unit 432 of the home gateway device 4 receives the information indicating the successful connection and enters a wait state for data such as connection instruction information transmitted from the access management server device 2 (S1005). That is, the connection control unit 432 in the wait state monitors data communication from the access management server device 2 so as to be ready to operate the connection control unit 432 by information contained in data upon reception of the data.

It should be noted that the aforementioned SIP is normally used as a communication protocol between the access management server and the connection device (outside-home communication device 1, home gateway device 4) including device registration request information upon the device access start process. The device registration request information in the device access start process corresponds to the REGISTER request in the SIP.

It should be noted that in the aforementioned example, explanation was given on the device access start process between the home gateway device 4 and the access management server device 2. The same procedure is performed in the case of the outside-home communication device 1. In the initialization process such as device start, the connection control unit 13 of the outside-home communication device 1 transmits device registration request information containing address information and authentication information from the communication control unit 14 to the access management server device 2 via the communication medium 7 (S1001). In the access management server device 2, authentication information matched with the authentication information contained in the device registration request information from the outside-home communication device 1 is searched in the authentication information management database. That is, an authentication process is performed (S1002).

If no authentication information is matched, i.e., if the authentication has failed, the access management server device 2 returns information indication connection rejection to the outside-home communication device 1. Upon reception of the connection rejection information, the outside-home communication device 1 displays a message that the connection with the access management server device 2 has failed on the output unit, thereby terminating the access start process.

On the other hand, when there exists authentication information matched with the authentication information contained in the device registration request information, i.e., if the authentication is successful, the address information contained in the device registration request information is registered in the connection management database (S1003) and information indicating the successful connection is returned to the outside-home communication device 1 (S1004). The connection control unit 13 of the outside-home communication device 1 receives the information indicating the successful connection and enters a wait state for receiving data such as connection instruction information transmitted from the access management server device 2 (S1005).

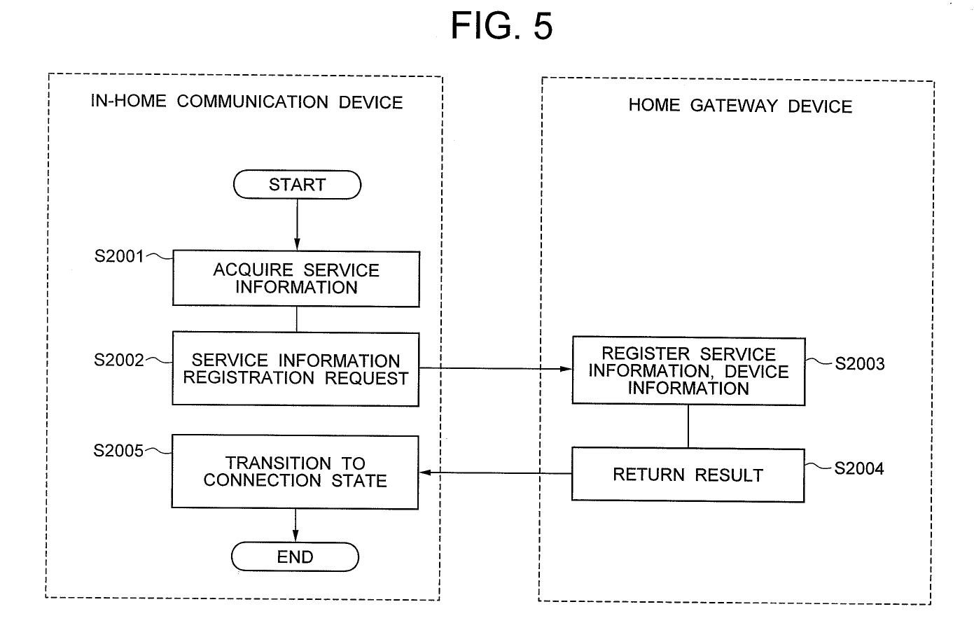

FIG. 5 is a flowchart for executing the service registration process (S2000).

In the initialization process such as operation start, the service execution unit 51 of the in-home communication device 5 included in the in-home system 6 acquires service information including a device ID and a service ID (S2001). The device ID used here is an identifier for identifying the in-home communication device 5. The identifier may be allocated in advance and held in the main storage of the in-home communication device 5 or a mechanism for adding the identifier to the communication data by the communication control unit 5 may be added.

Moreover, the service information used here is an identifier allocated to a service which can be executed in the service execution unit 51, i.e., a service which can be executed in linkage by communicating with the outside-home communication device 1 corresponding to the same service such as a service name, a device name which can be executed, a character string containing a service name and a version number, i.e., a character string unique to each service which is contained in advance in a program and data constituting the service execution unit 51.

Next, the service execution unit 51 of the in-home communication device 5 transmits service registration request information containing service information from the communication control unit 54 to the home gateway device 4 via the communication medium 8 (S2002).

In the home gateway device 4, the service management device 431 registers the device ID contained in the service registration request and the service ID contained in the service information together with the device address corresponding to the in-home communication device 5 in the service information database 4311 (S2003) and returns information indicating that registration is complete to the in-home communication device 5 (S2004). The service execution unit 51 of the in-home communication device 5 receives the information indicating that the registration is complete, and then transmits connection waiting instruction information to the communication setting unit 521 of the peer-to-peer communication unit 52 and enters the operation wait state, which continues until the communication setting unit 521 starts the peer-to-peer communication with the outside-home communication device 1 (S2005). On the other hand, the communication setting unit 521 receives the connection waiting instruction information from the service execution unit 51 and enters a state for waiting for data such as connection instruction information transmitted from the home gateway device 4. That is, the communication setting unit 521 in the wait state monitors the data communication from the home gateway device 4 so as to operate the communication setting unit 521 by the information contained in data upon reception of the data.

It should be noted that the service ID used here is contained in advance in the program or data constituting the service execution unit. However, it is also possible to use a service ID acquired by a separate procedure and retained before the service registration process. For example, a service management server device may be connected to the communication medium 7 of the outside-home communication system shown in FIG. 1, so that the outside-home communication device 1 and the in-home communication device 5 acquires information including a service ID from the server device at the timing of making an application for a service, subscription (registration), or charging. Moreover, it is also possible to hold a service ID in one of the outside-home communication device 1 and the in-home communication device 5 which execute a service in linkage with each other so that the other acquires a service ID by another procedure before the service registration process.

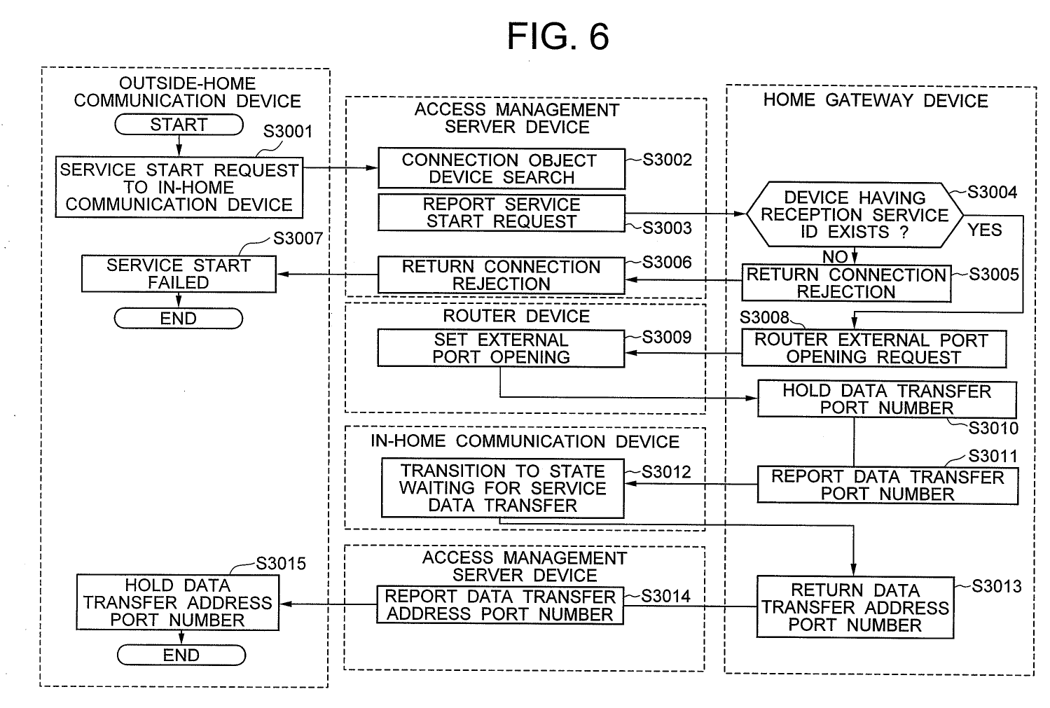

FIG. 6 is a flowchart of processes executed in the service execution start process (S3000).

In order to start a service execution linked with the in-home communication device 5, the outside-home communication device 1 transmits connection instruction information containing address information and service information from the communication control unit 14 to the home gateway device 4 via the communication medium 7, the router device 3, and the communication medium 8 (S3001). The address information used here may be, for example, URI (Uniform Resource Identifiers) for identifying the home gateway device 4 being connected to the in-home communication device 5 and it is assumed that the service execution unit 11 has acquired it in advance. Moreover, the service information is a service ID of the service operating in linkage with the in-home communication device 5.

The access management server device 2 firstly searches for address information which is matched with the address information contained in the connection instruction information from the outside-home communication device 1 (S3002) in the communication management database. As a result, if no address information is matched, the access management server device 2 returns information indicating that the connection destination is unknown to the outside-home communication device 1. When the connection control unit 132 of the outside-home communication device 1 receives the information that the connection destination is unknown, the connection control unit 132 displays a message that the connection destination is unknown on the output unit, thereby terminating the service execution start process.

On the other hand, when there is address information matched with the address information contained in the connection instruction information, the connection instruction information is transmitted (transferred) to the home gateway device 4 corresponding to the address information (S3003). In the home gateway device 4, the connection control unit 432 of the connection management unit 43 receives the connection instruction information and searches for the reception service ID matched with the service information (service ID) contained in the connection instruction information in the service information database 4311 (S3004). If no reception service ID is matched, the connection control unit 432 returns information indicating that connection is rejected to the access management server device 2 (S3005). Upon reception of this connection reject information, the access management server device 2 transmits (transfers) the information indicating that the connection is rejected to the outside-home communication device 1 which has transmitted the connection instruction information (S3006). Upon reception of the connection rejection information, the connection control unit 132 of the outside-home communication device 1 displays a message on the output unit that the connection with the in-home communication device 5 has failed upon service execution start, thereby terminating the service execution start process (S3007).

On the other hand, if there is a reception service ID matched with the service ID contained in the connection instruction information, the connection control unit 432 of the home gateway device 4 acquires the device ID and the device address of the in-home communication device 5 corresponding to the reception service ID from the service information database 4311 and associates or correlates (releases) the external port of the router device 3 with the device address of the in-home communication device 5 and the internal port number. The connection control unit 432 transmits conversion setting request information containing conversion setting to the router device 3 via the communication medium 8 so that the communication from the outside-home communication device 1 can reach the in-home communication device 5 in the in-home system (S3008). The conversion setting information used here includes the external port number of the router device 3, correlated or associated internal port number and the device address of the in-home communication device 5. Moreover, the external port number and the internal port number used are those which are not registered in the port number conversion information in the port information database 4331 (not overlapped, no matched information existing). The port number decision method may be, for example, selecting a younger number not overlapped within an effective range or selecting a random number within the effective range. Moreover, if there is no limit on the router device 3 and the in-home communication device 5, it is preferable that the external port number be identical to the internal port number.

Next, in the router device 3, the port conversion control unit receives conversion setting request information and adds a new port conversion setting to the port conversion unit of the router device 3 according to the external port number, the internal port number, and the device address contained in the conversion setting request information (S3009). If the port number setting of the router device 3 has been already used by another device, steps S3008 to S3009 are repeated until the port conversion setting is successful.

Next, in the home gateway device 4, the connection control unit 432 registers the device address, the external port number, the internal port number, and the device ID of the in-home communication device which has set the port conversion and the service ID of the reception service using the port conversion in the port information database 4331 (S3010) and transmits connection instruction information including the internal port number for receiving communication from the outside-home communication device 1 to the in-home communication device 5 (S3011).

In the in-home communication device 5, the communication setting unit 521 in the data wait state set by the service registration process receives the connection instruction information and enters a state for waiting for a communication from the outside-home communication device 1 with the internal port number contained in the connection instruction information (S3012). That is, the communication setting unit 521 is a wait state for monitoring a connection request from the outside-home communication device 1 and being ready for operating the communication setting unit 521 according to the information included in data upon reception of the data.

Next, in the home gateway device 4, the connection control unit 432 returns connection permission information including address information required for communication with the in-home communication device 5 (the device address and the external port number of the router device 3) and the device ID of the in-home communication device 5 to the access management server device 2 (S3013). Upon reception of the connection permission information, the access management server device 2 transfers the connection permission information to the outside-home communication device 1 which has transmitted the connection instruction information (S3014). Upon reception of the connection permission information, the connection control unit 132 of the outside-home communication device 1 holds the device ID contained in the connection permission information and reports the address information to the communication setting unit 121 of the peer-to-peer communication unit 12. The communication setting unit 121 holds the address information for data transfer process (S3015).

It should be noted that the connection instruction information transmitted by the access management server device 2 and connection devices (the outside-home communication device 1, the home gateway device 4) corresponds to the INVITE request in the SIP.

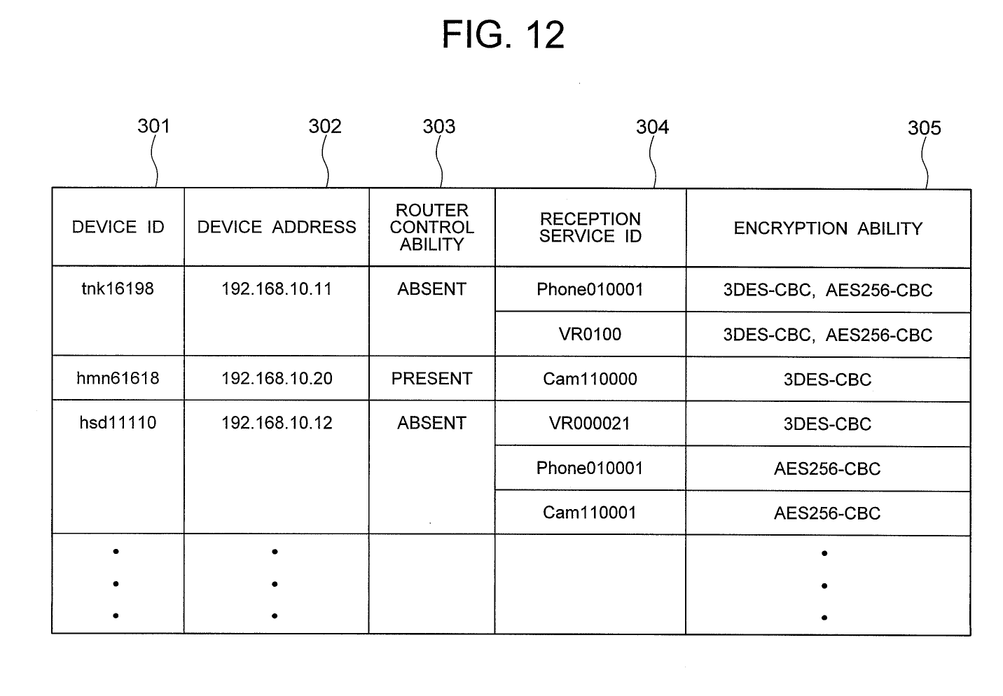

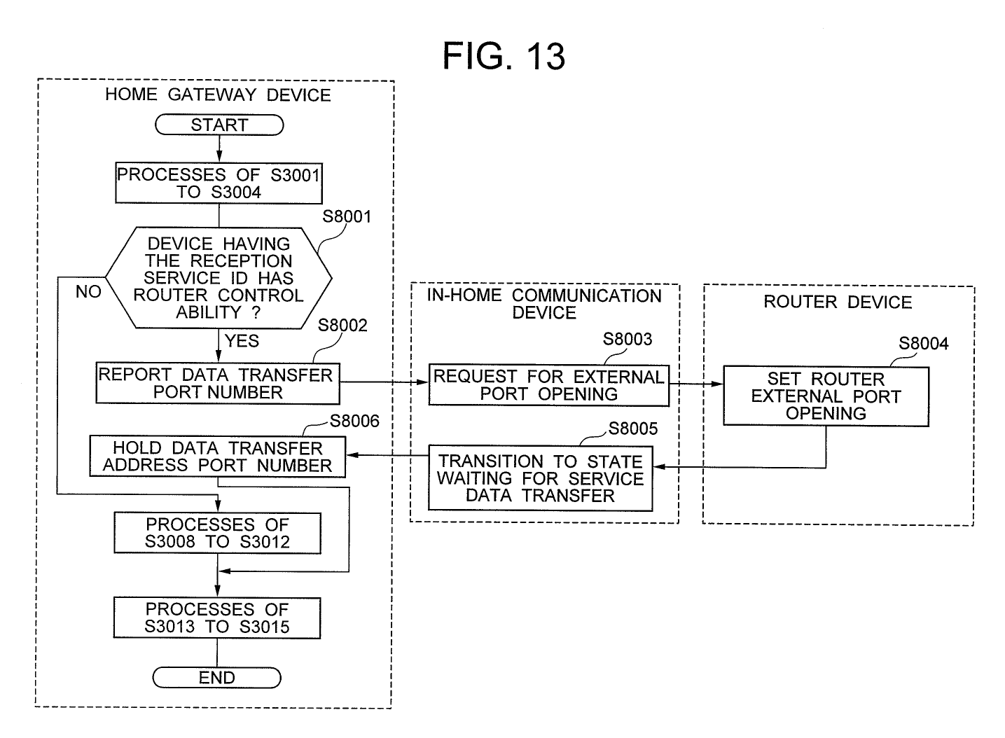

It should be noted that in step S3008 of the aforementioned service execution start process, the connection control unit 432 of the home gateway device 4 transmits the conversion setting request information to the router device 3 and requests for correlating or associating the external port of the router device 3 with the internal port. However, it is also possible that the in-home communication device 5 corresponding to the reception service transmits conversion setting request information to the router device 3. In this case, the in-home communication device 5 has a function of transmitting the conversion setting request information to the router device 3. Moreover, as shown in FIG. 12, the service information database 4311 additionally includes router control ability information 303 as a term indicating whether the function of transmitting the conversion setting request information to the router device 3 is provided. FIG. 13 is a flowchart of the processes executed in the service execution start process in this case.

The processes up to step S3004 are identical to the processes shown in the flowchart of FIG. 6. Next, the connection control unit 432 of the home gateway device 4 acquires the device ID, the device address, and the router control ability information of the in-home communication device 5 corresponding to the reception service ID from the service information database 4311 and judges whether the router control ability information indicates that “the router control ability is present” (S8001).

When the router control ability information of the in-home communication device 5 indicates that “the router control ability is absent”, the processes of steps S3008 to S3012 in FIG. 6 are executed and then the processes of steps S3013 to S3015 of FIG. 6 are executed hereafter.

On the other hand, when the router control ability information of the in-home communication device 5 indicates that “the router control ability is present”, the home gateway device 4 associates the external port of the router device 3 with the device address and the internal port number of the in-home communication device 5, decides an internal port number which is associated with the external port number so that communication from the outside-home communication device 1 can reach the in-home communication device 5 in the home network system 6, and transmits the connection instruction information containing the external port number and the internal port number to the in-home communication device 5 (S8002). Here, the external port number and the internal port number used are port numbers not registered (not duplicated, no matched information existing) in the port number conversion information in the port information database 4331. The method for deciding the port number may be, for example, selecting a not duplicated number from a younger number within an effective range or selecting a random number in the effective range. Moreover, if there is no limit on the router device 3 or the in-home communication device 5, it is preferable that the external port number be identical to the internal port number.

Next, in the in-home communication device 5, the communication setting unit 521 set to the data wait state by the service registration process receives the connection instruction information and transmits the external port number and the internal port number contained in the connection instruction information and conversion setting request information containing the device address of the in-home communication device 5 to the router device 3 via the communication medium 8 (S8003). In the router device 3, the port conversion control unit receives the conversion setting request information and adds a new port conversion setting to the port conversion unit of the router device 3 according to the external port number, the internal port number, and the device address contained in the conversion setting request information (S8004). If the port number setting of the router device 3 has been used by another device or the like, the steps S8001 to S8004 are repeated until the port conversion setting is successful.

Next, in the in-home communication device 5, the communication setting unit 521 transmits the port conversion setting information containing the external port number, the internal port number and the device address subjected to the port conversion setting to the home gateway device 4 and enters a state for waiting for communication from the outside-home communication device 1 with the internal port number (S8005). That is, the communication setting unit 521 is waiting while monitoring a connection request from the outside-home communication device 1 and being ready for operating the communication setting unit 521 by the information contained in data if one is received.

In the home gateway device 4, the connection control unit 432 receives the port conversion setting information, registers the device ID of the in-home communication device and the reception service together with the device address, the external port number, and the internal port number of the in-home communication device contained in the port conversion setting information in the port information database 4331 (S8006) and then the processes of the steps S3013 to S3015 of FIG. 6 are executed.

It should be noted that in the aforementioned service execution start process shown in the flowchart of FIG. 13, in step S8002, the internal port number to be associated or correlated with the external port number is decided by the home gateway device 4. However, it is also possible to be decided by the in-home communication device 5 in step S8003. In this case, the port conversion setting information is not decided in step S8002 and the connection instruction information transmitted by the home gateway device 4 to the in-home communication device 5 does not contain the external port number and the internal port number.

It should be noted that in the aforementioned service execution start process, the connection instruction information transmitted from the home gateway device 4 to the in-home communication device 5 contains encryption information of the peer-to-peer communication (encrypted communication) between the outside-home communication device 1 and the in-home communication device 5 in the service data transfer process, so that encrypted key can be switched for each linkage service, there by performing the peer-to-peer communication assuring security. The encryption information indicates a policy in encrypted communication between devices containing an encryption algorithm, an encryption key length, an encryption key, and the like. Moreover, the encryption information acquisition procedure in the service execution start process may be a method for reporting by the access management server device 2, a method for reporting from the outside-home communication device 1 to the in-home communication device 5, a method for reporting from the in-home communication device 5 or the home gateway device 4 to the outside-home communication device 1, and the like.

In the method reporting the encryption information by the access management server device 2, the access management server device 2 decides encryption information. The access management server device 2 notifies the in-home communication device 5 by including the encryption information in the connection instruction information transmitted to the home gateway device 4 in step S3003 and notifies the outside-home communication device 1 by including the encryption information in the connection permission information transmitted to the outside-home communication device 1 in step 3014. In this case, the home gateway device 4 makes the connection instruction information transmitted to the in-home communication device 5 include the encryption information in step 3011 so that the in-home communication device can acquire encryption information. In step 3012, the communication setting unit 521 is set to a state for waiting for the communication from the outside-home communication device 1 and encryption information is set in the encrypted communication unit 522. Moreover, in the outside-home communication device 1, in step S3015, the communication setting unit 121 holds the address information contained in the connection permission information and sets the encryption information contained in the connection permission information in the encrypted communication unit 122.

Moreover, in this method, in order to decide the applicable encryption information in each device, the access management server device 2 requires a database for registering the content of the encryption information such as applicable encryption algorithm for each device. The timing of the registration of the encryption function content may be, for example, the device access start process (S1000). In this case, in step S1001, the device registration request information transmitted by the home gateway device 4 includes the device encryption function content and in step S1003, the access management server device 2 registers the encryption function content at the time of the device registration.

Moreover, in the method for reporting the encryption information from the outside-home communication device 1 to the in-home communication device 5, the outside-home communication device 1 decides the encryption information and in step S3001, the encryption information is made to be included in the connection instruction information transmitted to the access management server device 2, thereby reporting the encryption information to the home gateway device 4. In step S3011, the home gateway device 4 has the encryption information included in the connection instruction information transmitted to the in-home communication device 5 so that the in-home communication device 5 can acquire the encryption information. In step 3012, the communication setting unit 521 is set to a state for waiting for communication from the outside-home communication device 1 and sets encryption information in the encrypted communication unit 522.

Moreover, in the method for reporting the encryption information from the in-home communication device 5 to the outside-home communication device 1, the in-home communication device 5 decides the encryption information. In step S3012, the in-home communication device 5 transmits the encryption information to the home gateway device 4. In step S3013, the home gateway device 4 has the encryption information included in the connection permission information transmitted to the access management server device 2, thereby reporting the encryption information to the outside-home communication device 1. In this case, in the outside-home communication device 1, the communication setting unit 121 holds the address information contained in the connection permission information and sets the encryption information contained in the connection permission information in the encrypted communication unit 122 in step S3015. Moreover, the outside-home communication device has the encryption function content included in the connection instruction information transmitted to the access management server device 2 by the outside-home communication device 1 in step S3001, thereby making it possible to acquire the encryption function content of the outside-home communication device 1 for deciding the encryption information applicable to the outside-home communication device 1. In this case, the home gateway device has the encryption function content included in the connection instruction information transmitted to the in-home communication device 5 in step 3011, so that the in-home communication device 5 acquires the encryption information content of the outside-home communication device.

Moreover, in the method for reporting the encryption information from the home gateway device 4 to the outside-home communication device 1, the home gateway device 4 decides the encryption information and, in step S3011, transmits the encryption information to the in-home communication device 5. In step S3013, the home gateway device 4 has the encryption information included in the connection permission information transmitted to the access management server device 2, thereby reporting the encryption information to the outside-home communication device 1.

In this case, the in-home communication device 5, in step S3012, sets the communication setting unit 521 to a state for waiting for communication from the outside-home communication device 1 and sets the encryption information in the encrypted communication unit 522. Moreover, in the outside-home communication device 1, in step S3015, the communication setting unit 121 holds the address information contained in the connection permission information and sets the encryption information contained in the connection permission information in the encrypted communication unit 122. Moreover, in this method, in order to decide encryption information applicable for each device, the home gateway device 4 is required to manage the contents of the encryption function (encryption ability) for each of the in-home communication device 5 such as applicable encryption algorithm. That is, as shown in FIG. 12, the encryption ability is added to terms of the service information database 4311 and held in association or correlation with the reception service ID. The timing of registration of the encryption function content may be, for example, the service registration process (S2000).

In this case, in step S2002, the service registration request information transmitted by the in-home communication device 5 includes the device encryption function content. In step S2003, when the home gateway device 4 performs registration in the service information database 4311, it also registers the encryption ability. Moreover, by including the encryption ability in the connection instruction information transmitted to the access management server device 2 by the outside-home communication device 1 in step S3001, the home gateway device 4 can acquire the encryption ability of the outside-home communication device 1 for deciding the encryption information applicable for the outside-home communication device 1.

It should be noted that the aforementioned service execution start process may be operated by the same procedure even when the in-home communication device 5 includes a plurality of service execution units 51.

It should be noted that in the aforementioned service execution start process, if a plurality of in-home communication devices 5 contained in the in-home system 6 registers the same reception service ID, it is necessary to perform a process for identifying the in-home communication device 5 to which the connection instruction information is to be reported (as the linkage service destination). As a method for identifying the in-home communication device 5, there are a method for instructing the device ID of the in-home communication device of the connection destination, a method for returning information on a plurality of devices which can be connected, a method for rejecting connection, and the like.

In the method for instructing the device ID of the in-home communication device of the connection destination in the connection instruction information, the outside-home communication device 1 acquires in advance the device ID which is an identifier for identifying the in-home communication device 5 as the connection destination. In step S3001, the connection instruction information to be transmitted to the access management server device 2 is made to include the device ID, so as to report the device ID of the connection destination in-home communication device 5 to the home gateway device 4 and in step S3004, the home gateway device 4 adds a device ID in addition to the service ID contained in the connection instruction information as conditions for judging the service reception, thereby making it possible to identify the in-home communication device 5 when the reception service is overlapped.

In the method for returning information on a plurality of devices which can be connected, when the home gateway device 4 judges the service reception in step S3004, if a plurality of service IDs in the service information database 4311 coincide with the service ID contained in the connection instruction information, the connection rejection is decided and processes of steps S3005 to S3007 for connection rejection are performed. However, by including information (device information) on the plurality of in-home communication devices 5 corresponding to the connection rejection information, the outside-home communication device 1 can receive the information for selecting the connection destination.

The device information used here contains the device ID. Furthermore, the device information may include identification information such as a unique name (nickname) of the device, and the device installation location. In this case, those information may be added to the terms of the service information database 4311 managing the reception service information on the in-home communication device and may be included in the service registration request information transmitted by the in-home communication device 5 in the service registration process (S2000).

On the other hand, in the outside-home communication device 1 which has received the connection rejection information, for example, the connection control unit 132 may display the device information on the plurality of in-home communication devices contained in the connection rejection information on the output unit so that a user can select from the input unit or automatic selection is performed from the device information, so that the device ID of the selected in-home communication device 5 may be identified so as to identify the in-home communication device 5 of the connection destination by using “the method for instructing the device ID of the in-home communication device of the connection destination in the connection instruction information”.

In the method of rejecting the connection, when the home gateway device 4 judges the service reception in step S3004, if a plurality of service IDs in the service information database 4311 coincide with the service ID contained in the connection instruction information, the connection rejection is decided and processes of steps S3005 to S3007 for the connection rejection are performed.

It should be noted that in the aforementioned service execution start process, by setting (filtering setting) such that a connection request other than the device address of the outside-home communication device of the connection origin is rejected in the router device 3 at the time of the port conversion setting of the router device 3, it is possible to prevent an unauthorized connection to the in-home communication device 5. In this case, by including the address information on the outside-home communication device 1 in the connection instruction information to be transmitted to the access management server device 2 by the outside-home communication device 1 in step S3001, it is possible to report the device address of the outside-home communication device 1 to the home gateway device 4. Moreover, by including the device address in the conversion setting request information to be transmitted to the router device 3 by the home gateway device 4 in step S3008, the router device 3 can perform filtering setting with the device address in addition to the port conversion setting in step S3009.

Moreover, in the aforementioned service execution start process, when the communication setting unit 521 of the in-home communication device 5 is in a state for waiting for the communication connection from the outside-home, a connection request other than the device address of the outside-home communication device is rejected so as to prevent an unauthorized connection to the in-home communication device 5.

In this case, by including the address information on the outside-home communication device 1 in the connection instruction information to be transmitted to the access management server device 2 by the outside-home communication device 1 in step S3001, the device address of the outside-home communication device 1 is reported to the home gateway 4. Moreover, by including the device address in the connection instruction information to be transmitted to the in-home communication device 5 by the home gateway device 4 in step S3011, the communication setting unit 521 of the in-home communication device 5 enters a state for waiting for the communication from the outside-home under the limitation of the device address in step S3012.

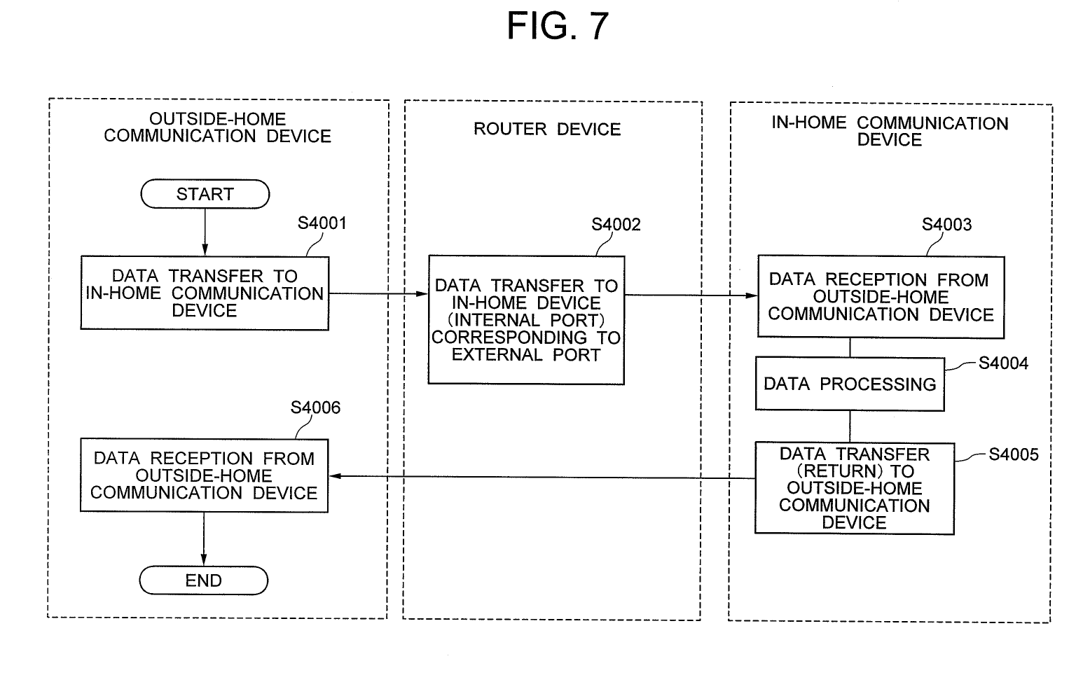

FIG. 7 is a flowchart of processes executed in the service data transfer process (S4000).

The service execution unit 11 of the outside-home communication device 1 transmits transfer data to the peer-to-peer communication unit 12 for data transfer in the execution of linked service with the in-home communication device 5. The communication setting unit 121 of the peer-to-peer communication unit 12 encrypts the transfer data at the encrypted communication unit 122 according to the encryption information set by the service execution start process and transmits it to the in-home communication device 5 from the communication control unit 14 via the communication medium 7, the router device 3, and the communication medium 8 based on the address information (device address, external port number) acquired and held upon the linked service execution start (S4001).

The transfer data is actually received by the router device 3. The port conversion unit acquires the corresponding device address and the internal port number from the external port number and transfers (relays or repeats out) the transfer data to the in-home communication device 5 as the corresponding device (S4002). Next, in the service execution start process, the communication setting unit 521 in the data wait state receives the transfer data (S4003).

The communication setting unit 521 decrypts the transfer data by the encrypted communication unit 522 according to the encryption information set by the service execution start process and transmits it to the service execution unit 51. The service execution unit 51 executes a linked service process according to the transfer dada (S4004). When data return to the outside-home communication device 1 is required as a result of the process in the service execution unit 51, the service execution unit 51 transmits transfer data to the peer-to-peer communication unit 52. The communication setting unit 521 of the peer-to-peer communication unit 52 encrypts the transfer data by the encrypted communication unit 522 according to the encryption information set by the service execution start process and transmits the encrypted transfer data to the in-home communication device 1 from the communication control unit 54 via the communication medium 8, the router device 3, and the communication medium 7 (S4005). In the outside-home communication device 1, the communication setting unit 121 receives the transfer data (S4006).

The communication setting unit 221 decrypts the transfer data by the encrypted communication unit 222 according to the encryption information set by the service execution start process and the transmits it to the service execution unit 21. The service execution unit 21 executes a linked service process according to the transfer data. When data transfer is further required, the processes of steps S4001 to S4006 are repeated.

It should be noted that in the aforementioned example, in the service execution start process (S3000), data is encrypted or decrypted according to the encryption information set in the encrypted communication unit 122 or the encrypted communication unit 522 before performing data transmission. However, it is also possible, for example, to add a process for exchanging encryption information upon data transfer between devices to set new encryption information after starting the peer-to-peer communication start. That is, the encryption information in the service execution start process is used in the encrypted communication for encryption information exchange in the service data transfer process.

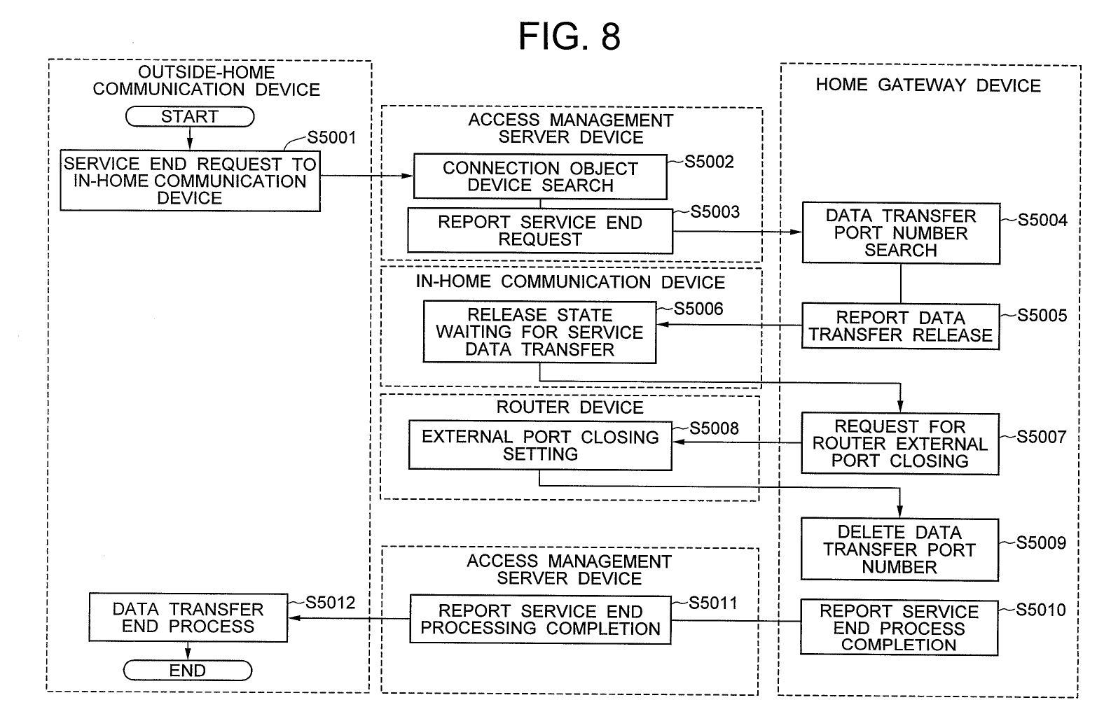

FIG. 8 is a flowchart of processes executed in the service execution end process (S5000).

The service execution unit 11 of the outside-home communication device 1 transmits connection end instruction information containing the device ID of the in-home communication device 5, the address information, and the service information to the home gateway device 4 from the communication control unit 14 via the communication medium 7, the router device 3, and the communication medium 8 in order to terminate execution of the linked service with the in-home communication device 5 (S5001). The access management server device 2 firstly searches the connection management database for address information which coincides with the address information contained in the connection instruction information from the outside-home communication device 1 (S5002). If no address coincides and the connection destination is unknown, the access management server device 2 returns information indicating that the connection destination is unknown to the outside-home communication device 1. The connection control unit 132 of the outside-home communication device 1 receives the information indicating that the connection destination is unknown and displays a message that the connection destination with the access management server device 2 is unknown on the output unit, thereby terminating the service execution end process.

On the other hand, if address information coinciding with the address information contained in the connection end instruction information exists, the connection end instruction information is transmitted (transferred) to the home gateway device 4 corresponding to the address information (S5003). In the home gateway device 4, the connection control unit 432 of the connection management unit 43 receives the connection end instruction information and searches the service information database 4311 for the reception service ID coinciding with the device ID and the service ID contained in the connection end instruction information (S5004). If no reception service ID coincides and connection is rejected, the connection control unit 432 returns information indicating that the connection is rejected to the access management server device 2. The access management server device 2 receives the connection rejection information and transmits (transfers) the connection rejection information to the outside-home communication device 1 which has transmitted the connection end instruction information. The connection control unit 132 of the outside-home communication device 1 receives the connection rejection information and displays a message that connection with the in-home communication device 5 has failed upon service execution start on the output unit, and terminates the service execution end process.

On the other hand, when a reception service ID coinciding with the service ID contained in the connection end instruction information exists, the connection control unit 432 of the home gateway device 4 acquires the internal port number of the port conversion setting of the router device 3 corresponding to the reception service ID and the device ID from the port information database 4311 and the connection control unit 432 transmits the connection release instruction information to the in-home communication device 5 so as to terminate communication with the outside-home communication device 1 (S5005). In the in-home communication device 5, the communication setting unit 521 set to the data wait state in the service registration process receives this connection release instruction information and releases the wait state for communication from the outside-home communication device 1 (S5006). That is, monitoring of the data reception from the outside-home communication device 1 is terminated.

Next, the connection control unit 432 releases the association or correlation between the external port number and the device address of the router device 3 and the internal port number of the in-home communication device 5 and transmits a conversion setting request containing conversion release information via the communication medium 8 so as to terminate reach of the communication from the outside-home communication device 1 into the in-home system 6 (S5007). The conversion release information used here contains the external port number and the internal port number of the router device 3. Next, in the router device 3, the port conversion control unit receives the conversion setting request and deletes the port conversion setting from the port conversion unit of the router device 3 based on the external port number and the internal port number contained in the conversion setting request (S5008).

Next, in the home gateway device 4, the connection control unit 432 deletes the external port number, the internal port number, and the device address which is associated with the port conversion setting which has been deleted by the connection control unit 432, from the port information database 4331 (S5009) and returns the connection end information to the access management server device 2 (S5010). The access management server device 2 receives the connection end information and transfers the connection end information to the outside-home communication device 1 which has transmitted the connection release instruction information (S5011). The connection control unit 132 of the outside-home communication device 1 receives the connection end information and reports the data communication end with the in-home communication device 5 to the communication setting unit 121 of the peer-to-peer communication unit 12. The communication setting unit 121 terminates the data transfer (S5012).

It should be noted that the connection release instruction information delivered between the access management server device 2 and connection devices (the outside-home communication device 1, the home gateway device 4) corresponds to the BYE request in the SIP.

It should be noted that in step S5007 of the aforementioned service execution end process, the connection control unit 432 of the home gateway device 4 transmits the conversion setting request information to the router device 3 to request release of association or correlation between the external port and the internal port of the router device 3. However, the in-home communication device 5 corresponding to the reception service may transmit the conversion setting request information to the router device 3.

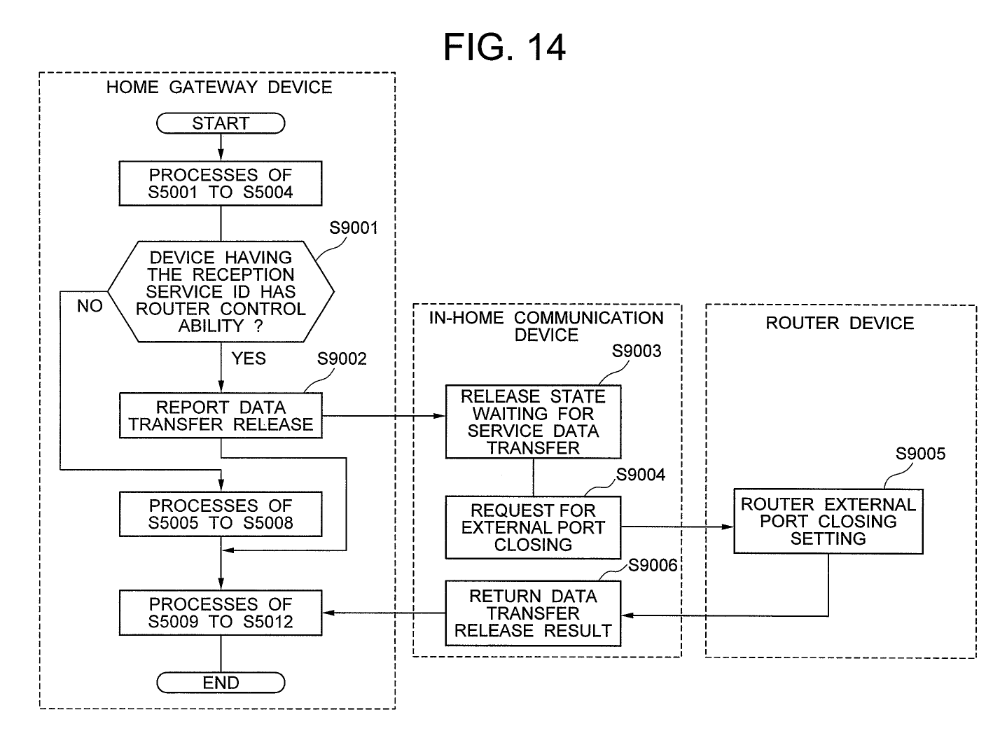

In this case, the in-home communication device 5 has a function of transmitting the conversion setting request information to the router device 3. Moreover, as shown in FIG. 12, the service information database 4311 has router control ability information 303 as a term indicating whether it has the function of transmitting the conversion setting request information to the router device 3. A flowchart of the process executed in this case of the service execution end process is shown in FIG. 14.

The processes up to S5004 are identical to the processes shown in the flowchart of FIG. 8. Next, the connection control unit 432 of the home gateway device 4 acquires the device ID, the device address, and the router control ability information of the in-home communication device 5 corresponding to the reception service ID from the service information database 4311 and judges whether the router control ability information indicates that “the router control ability is present” (S9001).

When the router control ability information on the in-home communication device 5 indicates that “the router control ability is absent”, processes of steps S5005 to S5008 in FIG. 8 are executed and then processes of steps S5009 to S5012 in FIG. 8 are executed.

On the other hand, when the router control ability information on the in-home communication device 5 indicates that “the router control ability is present”, the connection control unit 432 of the home gateway device 4 acquires the internal port number of the port conversion setting of the router device 3 corresponding to the reception service ID and the device ID from the port information database 4331 and the connection control unit 432 transmits the connection release instruction information including the internal port number to the in-home communication device 5 so as to terminate communication with the outside-home communication device 1 (S9002). In the in-home communication device 5, the communication setting unit 521 set to the data wait state by the service registration process receives the connection release instruction information and releases the wait state for communication from the outside-home communication device 1 (S9003). That is, monitoring of the data reception from the outside-home communication device 1 is terminated. Next, the communication setting unit 521 transmits a conversion setting request including conversion release information to release the association or correlation between the external port number of the router device 3 and the device address and the internal port number of the in-home communication device 5 via the communication medium 8, thereby terminating reach of the communication from the outside-home communication device 1 to the in-home system 6 (S9004).

The conversion release information used here includes the internal port number of the router device 3 corresponding to the service being executed between the outside-home communication device 1 and the in-home communication device 5 and this internal port number is included in the connection release instruction information transmitted from the home gateway device 4. Next, in the router device 3, the port conversion control unit receives conversion setting request information and deletes the port conversion setting from the port conversion unit of the router device 3 based on the internal port number contained in the conversion setting request information (S9005).

Next, in the in-home communication device 5, the communication setting unit 521 reports the port conversion deletion result to the home gateway 4 (S9006). Hereinafter, processes of steps S5009 to S5012 of FIG. 8 are executed.

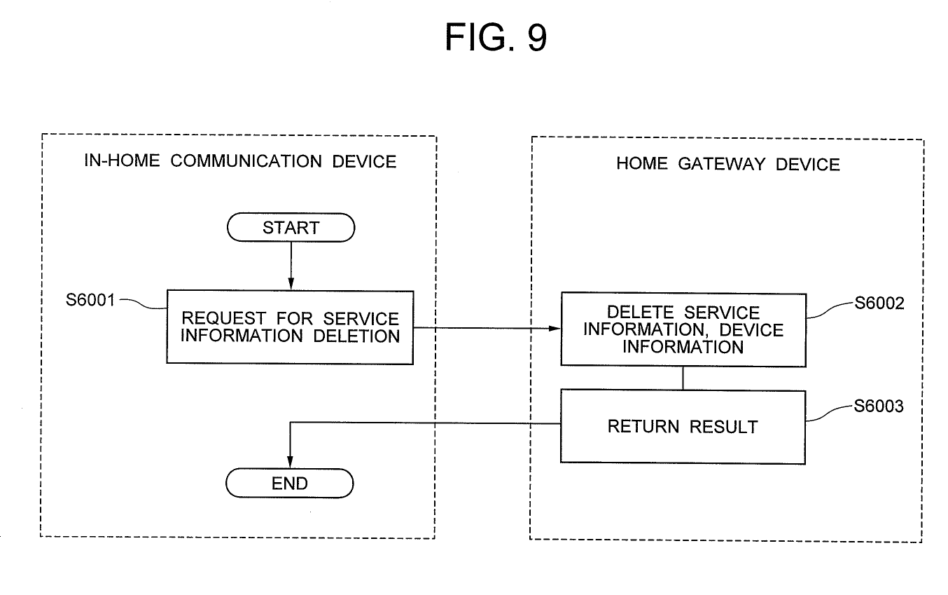

FIG. 9 is a flowchart of processes executed in the service deletion process (S6000).

The service execution unit 51 of the in-home communication device 5 contained in the in-home system 6 transmits service deletion request information including the device ID and service information (service ID) to the home gateway device 4 from the communication control unit 54 via the communication medium 8 upon termination process such as operation end (S6001). In the home gateway device 4, the service management unit 431 deletes the service ID contained in the service deletion request from the reception service ID term corresponding to the device ID in the service information database 4311 (S6002) and returns information indicating that deletion registration is complete to the in-home communication device 5 (S6003).

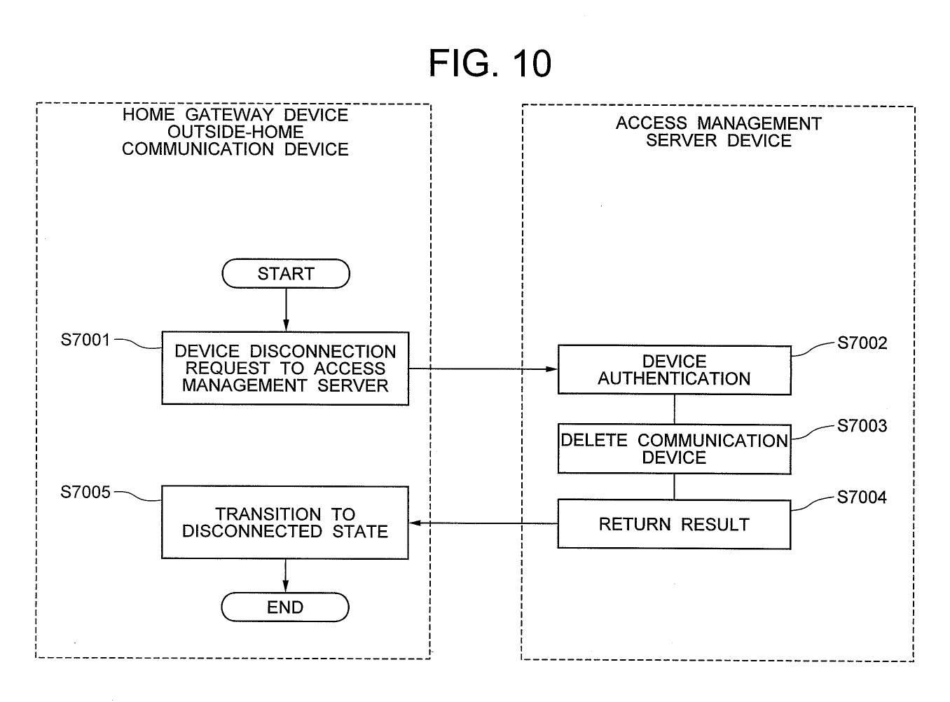

FIG. 10 is a flowchart of the processes executed in the device access end process (S7000).

The connection control unit 432 of the home gateway device 4 contained in the in-home system 6 transmits device deletion request information including authentication information to the access management server device 2 from the communication control unit 44 via the communication medium 8, the router device 3, and the communication medium 7 upon an end process such as device termination (S7001). The access management server device 2 searches the authentication information management database for authentication information matched with the authentication information contained in the device deletion request information from the home gateway device 4, i.e., performs an authentication process (S7002). If no authentication is matched and the authentication fails, the access management server device 2 returns information indicating that the connection is rejected to the home gateway device 4. The home gateway device 4 receives the connection rejection information and displays a massage that the connection with the access management server device 2 has failed on the output unit, thereby terminating the device access end process.

On the other hand, if authentication matched with the authentication information contained in the device deletion request information exists and the authentication is successful, the address information corresponding to the home gateway device 4 is deleted from the connection management database (S7003) and information indicating that deletion is successful is returned to the home gateway device 4 (S7004). The connection control unit 432 of the home gateway device 4 receives the information indicating that deletion is successful and then releases the data wait state from the access management server device 2 (S7005). That is, monitoring of data communication from the access management server device 2 is terminated. It should be noted that the device deletion request information delivered between the access management server device 2 and the connection devices (the outside-home communication device 1, the home gateway device 4) corresponds to the REGISTER (upon registration deletion) request in the SIP.

By the aforementioned steps (S1000 to S7000), in the in-home/outside-home communication system, the outside-home communication device and communicate with the in-home communication device by peer-to-peer and it is possible to reduce the load on the access management server device even in a large-capacity data communication such as video data.

Moreover, by the aforementioned steps to certify validity of the outside-home communication device by the access management server or the home gateway device, it is possible to reduce the load on the in-home communication device (load for certifying validity of the outside-home communication device).

Furthermore, the aforementioned steps perform connection management of the in-home communication device in the home gateway device. When a user accesses an in-home communication device by using an outside-home communication device, the in-home communication device to be connected is automatically judged. Accordingly, even when the number of the in-home communication devices connected to the home network is increased, it is possible to provide user-friendliness.

It should be noted that in the aforementioned example, the outside-home communication device 1 is a single device (outside-home device). However, the function of the outside-home communication device 1 and the database configuration may be, for example, installed in the server device of a service providing company. Moreover, it is possible to operate the outside-home communication device 1 by the same procedure even when the in-home system 6 is another in-home system having the same configuration as the in-home system 6.

Moreover, in the aforementioned example, the outside-home communication device 1 is authenticated by the access management server device 2. However, it is possible to add means for authenticating the validity of the connection device (outside-home communication device 1) by the home gateway device 4 and integratedly managing device authentication en bloc in the in-home system 6 by the home gateway device 4. In this case, an access authentication unit for authenticating the connection device (the outside-home communication device 1) and an authentication information management database having registered therein authentication information on the valid outside-home communication device 1 are added to the home gateway device 4; in step S3001 of the service execution start process (S3000), the outside-home communication device 1 transmits the authentication information by including it in the connection instruction information transmitted to the access management server device 2; in step S3003, the access management server device 2 transmits the authentication information by including it in the connection instruction information transmitted to the home gateway device 4; and before the service reception enabled/disabled judgment process in step S3004, the home gateway device 4 searches the authentication information management database for the authentication information matched with the authentication information contained in the connection instruction information from the access management server device 2. That is, a step of an authentication process is added.

The access authentication unit and the authentication information management database are the same as those contained in access management server device 2 of the in-home/outside-home communication system shown in FIG. 1. Moreover, in this case, it is possible to omit the step of the authentication process (S1002) in the access management server device 2 in the device access registration process (S1002) in the outside-home communication device 1.

Thus, when management of the device authentication in the in-home system 6 is integrated or made en bloc by the home gateway device 4, for example, by associating or correlating the device authentication with the reception service information, it is possible to realize an authentication process by associating or correlating the in-home communication device 5 with its service information such as setting the outside-home communication device 1 which can be connected for each of the reception services of the in-home communication device 5.

Moreover, when the home gateway device 4 in the aforementioned example has a service execution unit 51 and a peer-to-peer communication unit 52 which are the functions of the in-home communication device 5, the home gateway device 4 can virtually have a role of the in-home communication device 5. For example, the home gateway 4 can replace the service execution unit controlling a device not connected to the communication medium 8 so as to realize a service linked with the outside-home communication device 1.

Moreover, the functions of the router device 3 and the home gateway device 4 in the aforementioned example may be provided in a single device. In this case, the process for controlling the router device 3 by the home gateway device 4 (step S3008, step S3010, step S5007, step S5009, and the like) can be realized by not only by the communication protocol such as the UPnP but also by the internal data transfer, thereby omitting the router control unit 433 and the port information database 4331 of the connection management unit 43.

The aforementioned example assumes that the in-home device has the encryption ability. However, the home network is also connected to devices not having the encryption ability such as an air conditioner, a lamp, an electric key. Moreover, in the in-company LAN, there also exist devices not having an encrypted communication function.

Next, explanation will be given on an embodiment realizing a highly safe access to an in-home device having no encryption ability, i.e., a low processing ability from outside-home, by the home gateway device 4 having the peer-to-peer communication unit 52 which is the function of the in-home communication device 5, or realizing a highly safe access to an in-company device into which an encryption process cannot be built.

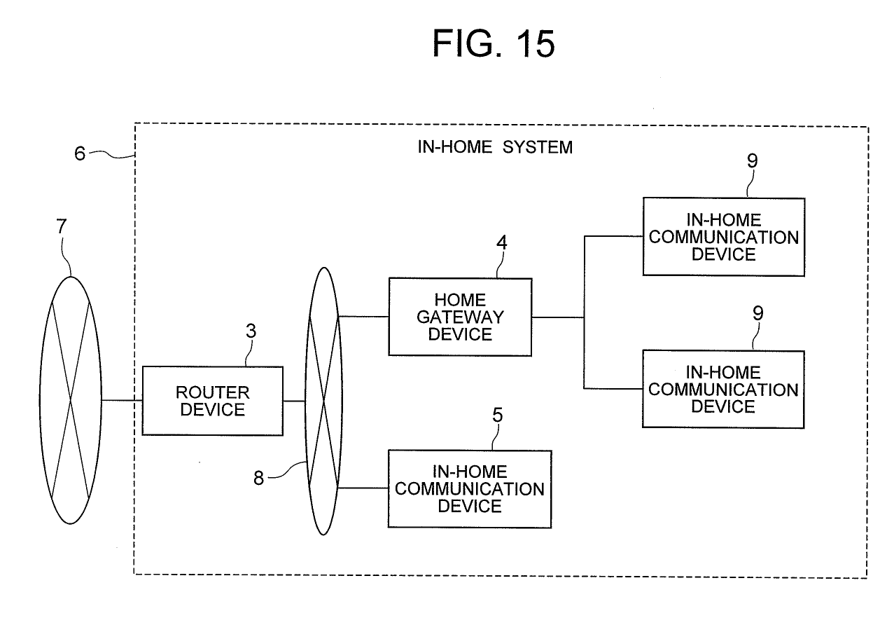

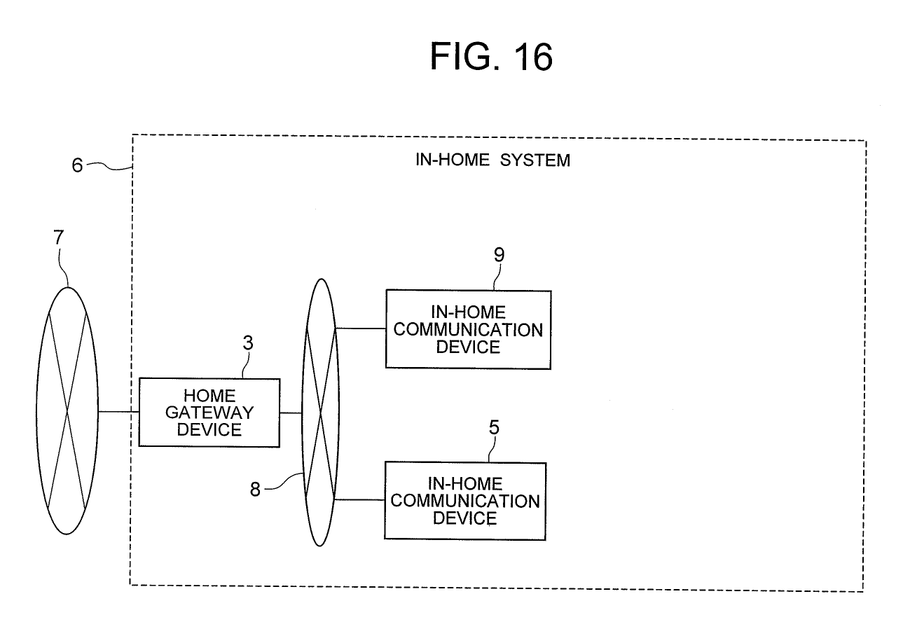

As shown in FIG. 15, the in-home communication device 9 having no encryption ability is connected directly to the home gateway device 4. One or more in-home communication devices 9 may be connected to the home gateway device 4. Moreover, as shown in FIG. 16, the home gateway device 4 may have a built-in function of the router device 3. In this case, the home gateway device 4 controls its port opening and closing by itself. A plurality of in-home communication devices 5 and a plurality of in-home communication devices 9 may be connected to the communication medium 8. Moreover, in FIG. 16, when each of the in-home communication devices has a global IP address, the home gateway device 4 may not have the built-in router function.

Next, explanation will be given on the hardware configuration of the home gateway device 4 and the in-home communication device 9 in the in-home system configuration shown in FIG. 15.

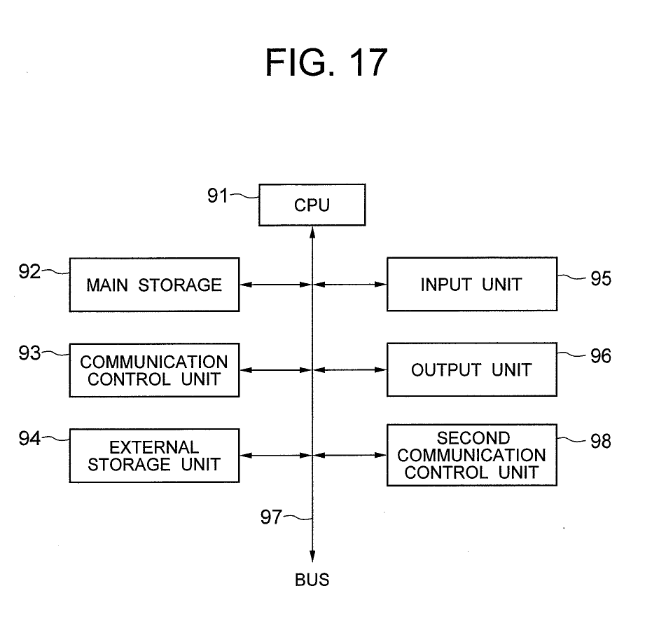

The home gateway device 4 shown in FIG. 15 may be realized by an information processing device having a normal hardware configuration capable of executing software. More specifically, as shown in FIG. 17, the home gateway device 4 includes a CPU (operation processing device) 91, a main storage 92, a communication control unit 93, an external storage unit 94, an input unit 95, an output unit 96, and a second communication control unit 98. The respective units are connected to one another via a bus 97 for delivering information required by the respective units.

The CPU (operation processing device) 91, the main storage 92, the communication control unit 93, the external storage unit 94, the input unit 95, and the output unit 96 in FIG. 17 are similar to the CPU (operation processing device) 91, the main storage 92, the communication control unit 93, the external storage unit 94, the input unit 95, and the output unit 96 in FIG. 2, respectively. The second communication unit 98 transmits/receives information (data) to/from the in-home communication device 9 and is realized, for example, by a network adapter and radio transmission/reception device. Moreover, in the home gateway 4 in FIG. 16, the second communication control unit 98 transmits/receives information (data) to/from a device connected to the same communication medium 8 via the communication medium 8 and is realized, for example, by a network adapter and radio transmission/reception device.

The in-home communication device 9 may be realized by an information processing device having normal hardware configuration capable of executing software shown in FIG. 2.

Next, explanation will be given on the function and the database configuration realized by execution of software by the home gateway device 4 and the in-home communication device 9.

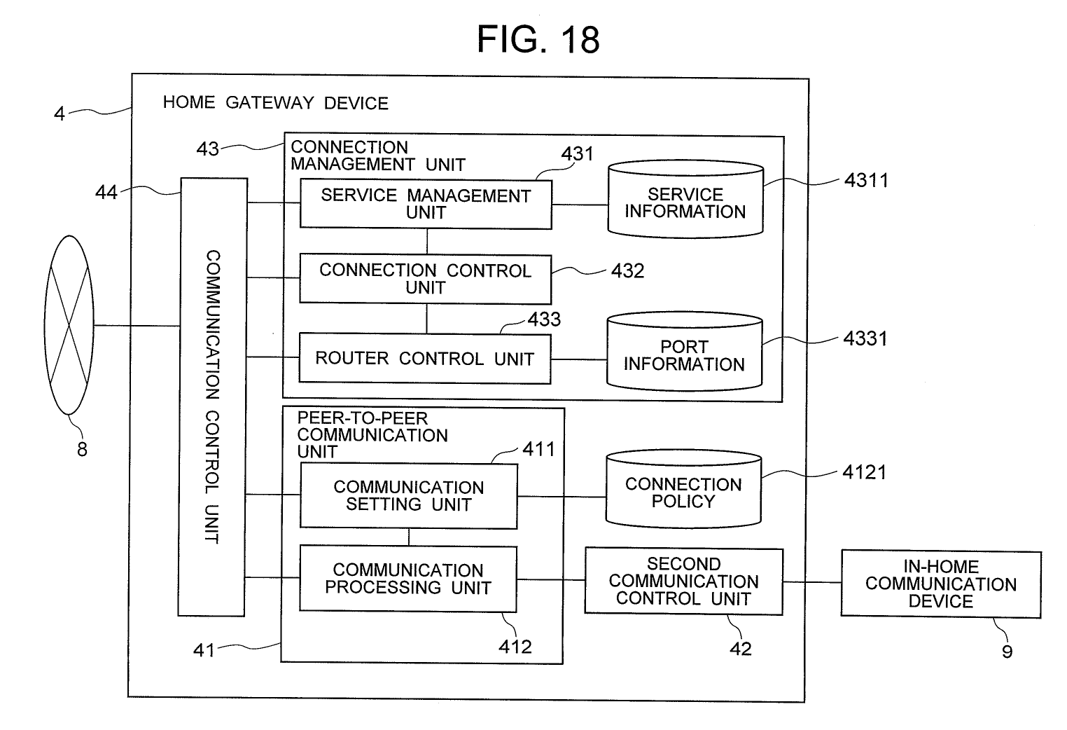

The home gateway device 4 is an information processing unit which decides the in-home communication device 9 to be connected by the outside-home communication device 1 according to the connection instruction information from the outside-home communication device 1 via the access management server device 2 and information on the in-home communication device 1 and performs setting required for peer-to-peer communication between them, thereby mediating peer-to-peer communication between the devices. As shown in FIG. 18, the home gateway device 4 includes a connection management unit 43, a communication control unit 44, a peer-to-peer communication unit 41, and a second communication control unit 42. The connection management unit 43 includes a service management unit 431, a connection control unit 432, and a router control unit 433. The peer-to-peer communication unit 41 includes a communication setting unit 411 and an encrypted communication unit 412. Furthermore, the external storage unit 94 of the home gateway device 4 contains a service information database 4311, a connection policy database 4121, and a port information database 4331.

The connection management unit 43 has a function of managing information (address information) for identifying an in-home communication device 9 contained in the in-home system 6, deciding the in-home communication device 9 to be connected according to the connection instruction information and management information transmitted from the outside-home communication device 1 via the access management server device 2, and controlling port conversion of the router device 3 so that data communication from the outside-home communication device 1 can be received.

The service management unit 431 has a function of managing the address information of the in-home communication device 9 by using the service information database 4311 and a function of deciding the in-home communication device 9 according to the connection instruction information transmitted from the outside-home communication device 1 and information managed by the service information database 4311.

The connection control unit 432 has a function of making a connection with the access management server device 2 via the communication control unit 44, a function of receiving the service connection instruction information from the outside-home communication device 1 from the access management server device 2, and a function of transmitting address information required for the access management server device 2 to perform data communication with the outside-home communication device 1.

The router control unit 433 has a function of transmitting port conversion setting information (external port number, internal port number, etc.) for relaying or repeating the data communication from the outside-home communication device 1 to the home gateway device 4 to the port conversion control unit of the router device 3 so as to set a port conversion, and a function of managing the port conversion setting information by using the port information database 4331.

The communication control unit 44 has a function of generating, interpreting, and communicating a message according to the communication protocol so that the communication control unit 41, the connection management unit 43, and functional units contained in this (the service management unit 431, the connection control unit 432, the router control unit 433) can communicate with the device connected to the communication medium (the router device 3) and the devices connected to the communication medium 7 via the router device 3 (the access management server device 2, the outside-home communication device 1).

The peer-to-peer communication unit 41 has a function of managing the information for judging the communication enabled/disabled state with the outside-home communication device 1 and the in-home communication device 9 by using the connection policy database 4121, and a function of mediating the data communication with the outside-home communication device 1 and the in-home communication device 9 according to the contents of the connection policy database 4121.

The communication setting unit 411 has a function of setting address information (IP address, port number, etc.) required for peer-to-peer data communication with an external device (the outside-home communication device 1) via the communication control device 44, and a function of setting encrypted information (including encryption method, encryption key, etc.) in the peer-to-peer encrypted communication.

The encrypted communication unit 412 has a function of decrypting the data received via the communication control unit 44 (data transfer from the outside-home communication device) by using the encrypted communication information set by the information transmitted from the communication setting unit 411 and transmitting the data via the second communication control unit and a function of encrypting the transmission data received via the second communication control unit (data transfer to the outside-home communication device) by using the encrypted communication information and transmitting it via the communication control unit 44.

The second communication control unit 42 has a function of generating, interpreting, and communicating a message according to the communication protocol so that the encrypted communication unit 412 can communicate with the in-home communication device 9.

The service information database 4311 integratedly manages the receivable service information en bloc on the in-home communication device 9 connected to the home gateway device 4. The service information database 4311 may be realized by the configuration shown in FIG. 3. At least the device address 102 should be registered.

The port information database 4331 manages information on the port number conversion setting corresponding to the in-home communication device 5 connected to the home gateway device 4. The port information database 4311 may be realized by the configuration shown in FIG. 11. At least the port number conversion information 203 should be registered.

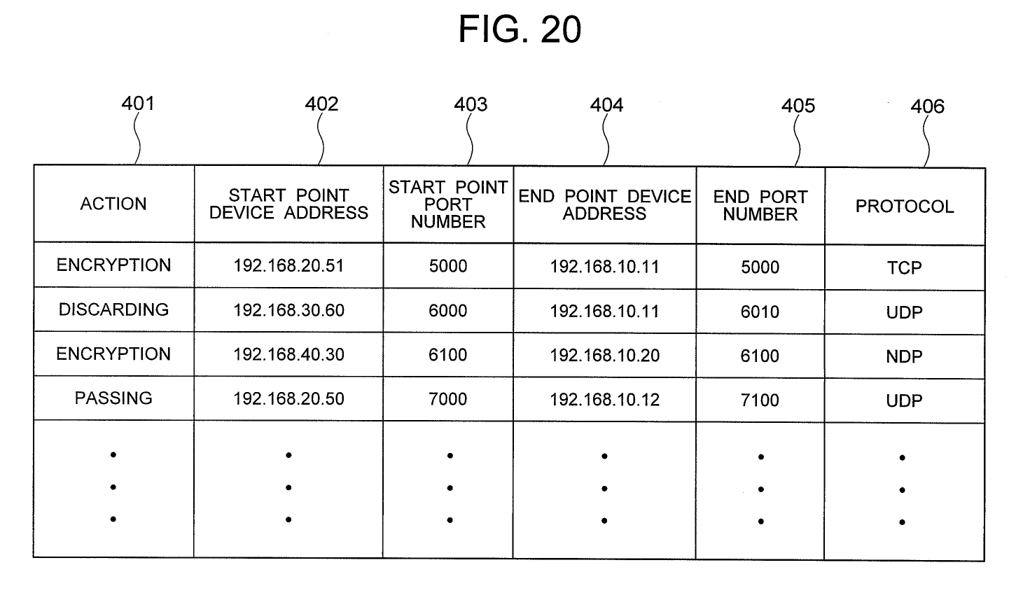

The connection policy database 4121 manages information for judging communication enabled/disabled state with the outside-home communication device 1 and the in-home communication device 9. As shown in FIG. 20, the connection policy database 4121 contains an action 401, a start point device address 402, a start point port number 403, an end point device address 404, an end point port number 405, and a protocol 406 for each of the in-home communication devices connected to the home gateway 4.

Encryption, passing, or discarding is set in the action 401. The encrypted communication unit 412 performs a process according to the content of the action 401 in the communication matched with the setting content (communication in which the start point device address 402, the start point port number 403, the end point device address 404, the end point port number 405, and the protocol 406 are matched).

When the action is encryption, the data received via the communication control unit 44 (data transfer from the outside-home communication device) is decrypted by using the encrypted communication information and transmitted via the second communication control unit. Moreover, the transmission data received via the second communication control unit (data transfer to the outside-home communication device) is encrypted by using the encrypted communication information before transmitted via the communication control unit 44.

When the action is passing, the data received via the communication control unit 44 (data transfer from the outside-home communication device) is directly transmitted as it is via the second communication control unit. Moreover, the transmission data received via the second communication control unit (data transfer to the outside-home communication device) is directly transmitted as it is via the communication control unit 44.

When the action is discarding, the data received via the communication control unit 44 (data transfer from the outside-home communication device) and the transmission data received via the second communication control unit (data transfer to the outside-home communication device) are both discarded.

For example, the contents of the first entry in FIG. 20 indicate that the communication between the outside-home communication device 1 and the home gateway device 4 is encrypted when the outside-home communication device 1 having the device address 192.178.20.51 performs communication by TCP (Transmission Control Protocol) to the reception port 5000 of the in-home communication device 9 having the device address 192.168.10.11.

It should be noted that in the communication not matched with the set contents (communication in which the start point device address 402, the start point port number 403, the end point device address 404, the end point port number 405, and the protocol 406 are not matched), a default action (encryption, passing, or discarding) decided in advance may be performed.

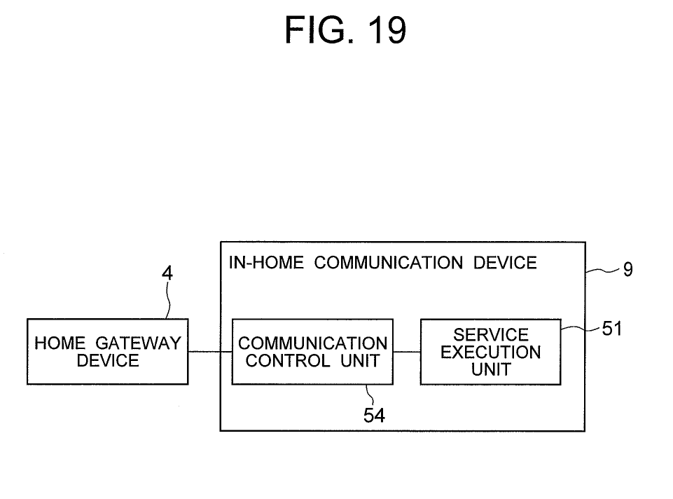

The in-home communication device 9 is an information processing device having a function of executing various services (such as a remote control service from the outside-home) by connection and linkage with the communication with the outside-home communication device 1. As shown in FIG. 19, the in-home communication device 9 includes a service execution unit 51 and a communication control unit 54.

The service execution unit 51 has a function of executing various services linked with the outside-home communication device 1. It should be noted that the system configuration shown in FIG. 19 includes only one service execution unit 51. However, a plurality of service execution units may be included. In this case, the in-home communication device 9 may simultaneously or selectively realize a service by separately linking with the plurality of outside-home communication devices or executing a plurality of services by linking with a single outside-home communication device.

The communication control unit 54 has a function of generating, interpreting, and communicating a message according to the communication protocol so that the service execution unit 51 can communicate with a device connected to the communication medium 7 via the home gateway device 4 (the outside-home communication device 1).

Next, explanation will be given on the outline of the service execution process on the in-home communication device by an authorized outside-home communication device executed in the in-home/outside-home communication system shown in FIG. 1 (and the home gateway device 4 in FIG. 18 and the in-home communication device 9 in FIG. 19).

In an example given here, the outside-home communication device 1 calls a service operating in the in-home communication device 9 existing in the in-home system 6 and acquires the process result.

The service execution process is realized by successively executing the following steps: a device access start process (S1100) performed before execution of linked service between devices for registering device address information required upon data transfer of connection instruction information between devices when the outside-home communication device 1 and the home gateway device 4 contained in the in-home system 6 are connected to the access server device 2, and performing device authentication; a service execution start process (S3100) in which the outside-home communication device 1 transmits the connection instruction information via the access management server device 2 to the home gateway device 4 so as to establish a peer-to-peer communication between the outside-home communication device 1 for executing a service and the in-home communication device 9 for performing service data transfer; a service data transfer process (S4100) for performing communication between the outside-home communication device 1 and the in-home communication device 9 upon service execution; a service execution end process (S5100) in which the outside-home communication device 1 transmits the connection end instruction information via the access management server device 2 to the home gateway device 4 so as to terminate service execution between the outside-home communication device 1 and the in-home communication device 9; and a device access end process (S7100) (for disconnection from the access management server device 2) so that the home gateway device does not receive a report from the access management server 2.

Here, the service execution process itself should only execute the steps of S3100, S4100, and S5100. The steps of S1100 are pre-processes for service execution performed upon device start and the steps of S7100 are post-processes for service execution performed upon device end.

Hereinafter, each of the steps (S1100, S3100, S4100, S5100, S7100) will be detailed.

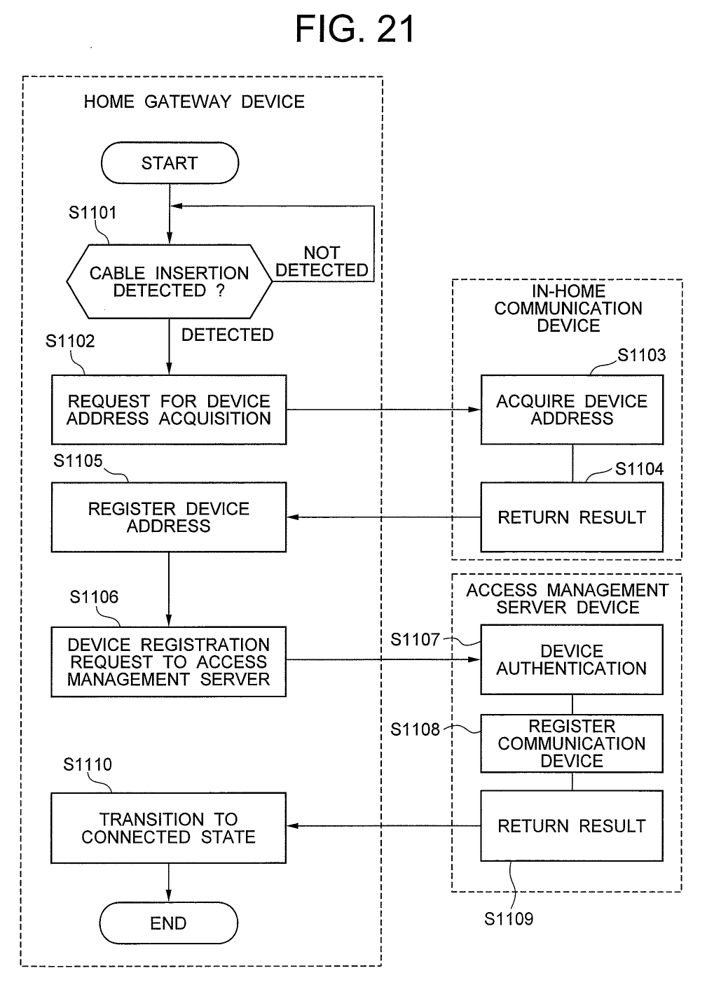

FIG. 21 is a flowchart of processes executed in the device access start process (S1100).

The service management unit 431 of the home gateway device 4 contained in the in-home system 6 detects whether a cable to be connected to the in-home communication device 9 is inserted in the second communication control unit 42 in the initialization process upon device start (S1101). If the cable is inserted, the service management unit 431 transmits a device address acquisition request from the second communication control unit 42 to the in-home communication device 9 (S1102). The communication control unit 54 of the in-home communication device 9 acquires its own device address (S1103) and returns the result to the home gateway device 4 (S1104). The service management unit 431 of the home gateway device 4 registers the returned device address in the service information database 4311 (S1105).

Next, in the initialization process upon device start, the connection control unit 432 of the home gateway device 4 transmits the address information (device address and URI) of the home gateway device 4, the address information (device address) of the in-home communication device 9 received in step S1105, and the device registration request information including authentication information from the communication control unit 44 via the communication medium 8, the router device 3, and the communication medium 7 to the access management server device 2 (S1106).

The access management server device 2, firstly, searches the authentication information management database for the authentication information matched with the authentication information contained in the device registration request information from the home gateway device 4, i.e., performs an authentication process (S1107).

As a result, if no authentication is matched and the authentication has failed, the access management server device 2 returns information indicating connection rejection to the home gateway device 4. The home gateway device 4 receives the connection rejection information and displays a message that the connection with the access management server device 2 has failed on the output unit, thereby terminating the device access start process.

On the other hand, if there exists authentication information matched with the authentication information contained in the device registration request information and the authentication is successful, the home gateway device 4 contained in the device registration request information and the address information of the in-home communication device 9 are registered in the connection management database (S1108) and information indicating the successful connection to the home gateway 4 (S1109). The connection control unit 432 of the home gateway device 4 receives the successful connection information and enters a state for waiting data such as connection instruction information transmitted from the access management server device 2 (S1110). That is, the connection control unit 431 waits in the state for monitoring the data communication from the access management server device 2 so as to be ready to operate the connection control unit 432 by the information contained in data upon reception of the data.

It should be noted that in the aforementioned example, the device access start process is performed in the home gateway device. In the case of the outside-home communication device 1, the same procedure as in the procedure shown in FIG. 4 is performed.

That is, in the initialization process upon the device start or the like, the connection control unit 13 of the outside-home communication device 1 transmits the device registration request information including the address information and the authentication information from the communication control unit 14 via the communication medium 7 to the access management server device 2 (S1001). The access management server device 2 searches the authentication information management database for the authentication information matched with the authentication information contained in the device registration request information from the outside-home communication device 1, i.e., performs an authentication process (S1002).

As a result, if no authentication information is matched and the authentication has failed, the access management server device 2 returns information indicating connection rejection to the outside-home communication device 1. The outside-home communication device 1 receives the connection rejection information and displays a message indicating that connection with the access management server device 2 has failed on the output unit, thereby terminating the device access start process.

On the other hand, if there exists authentication information matched with the authentication information contained in the device registration request information and the authentication is successful, the address information contained in the device registration request information is registered in the connection management database (S1003) and information on the successful connection is returned to the outside-home communication device 1 (S1004). The connection control unit 13 of the outside-home communication device 1 receives the successful connection information and enters a state for waiting for data such as connection instruction information transmitted from the access management server device 2 (S1005).

Moreover, when the user authentication is successful in the device access start process (S1100), the home gateway device 4 may be connected to the access management server device 2 so that device address information required upon data transfer of the connection instruction information between devices is registered and the device validity is confirmed. In this case, the home gateway device 4 should only include a means (device) for inputting information required for user authentication.

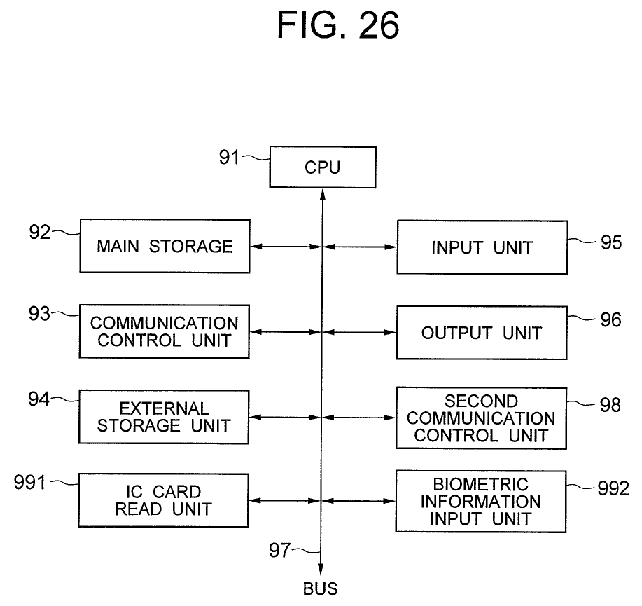

As shown in FIG. 26, the home gateway device 4 in this case includes a CPU (operation processing device) 91, a main storage 92, a communication control unit 93, an external storage unit 94, an input unit 95, an output unit 96, a second communication control unit 98, an IC card read unit 991, and a biometric information input unit 992. The respective units are connected to one another via a bus 97 so that necessary information can be delivered between the units.

The CPU (operation processing device) 91, the main storage 92, the communication control unit 93, the external storage unit 94, the input unit 95, the output unit 96, and the second communication control unit 98 in FIG. 26 are similar to the CPU (operation processing unit) 91, the main storage 92, the communication control unit 93, the external storage unit 94, the input unit 95, the output unit 96, and the second communication control unit in FIG. 17, respectively. The IC card read unit 991 is configured so that an IC card can be inserted so as to read the user information (password, fingerprint information, finger vein information, etc.) stored in the IC of the IC card. The biometric information input unit 992 is a device for reading the biometric information (fingerprint, finger vein, etc.) of the user. It should be noted that the biometric information input unit 992 is not indispensable.

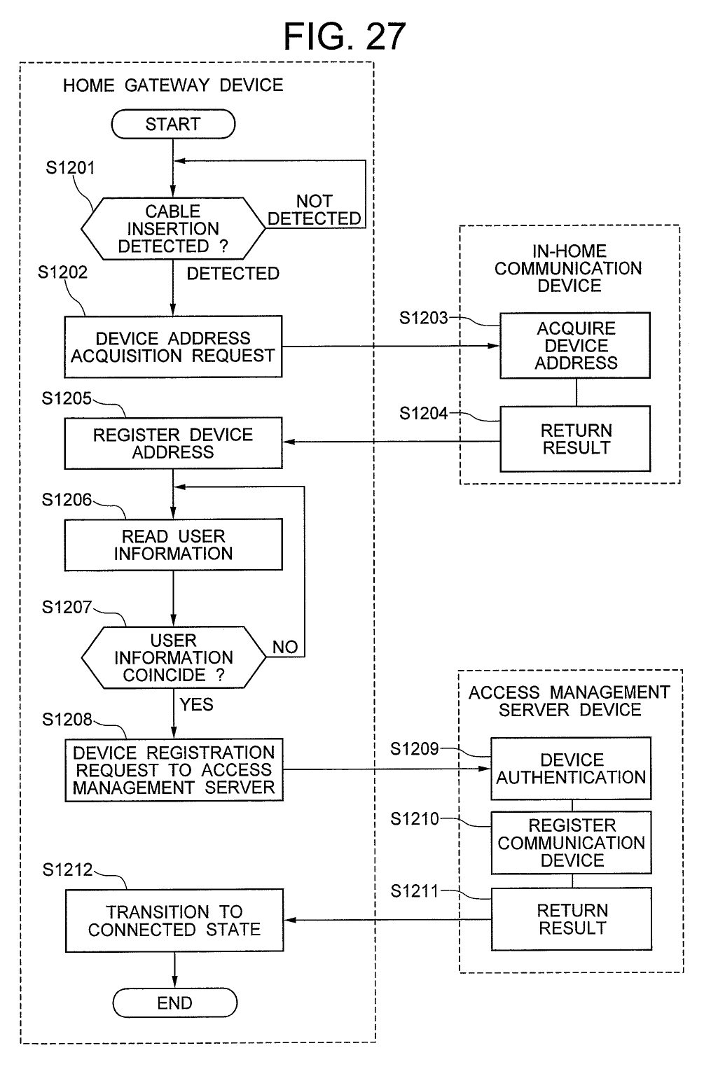

FIG. 27 is a flowchart of the processes executed in the device access start process (S1200) when the user authentication is used.

In the initialization process upon device start or the like, the service management unit 431 of the home gateway device 4 contained in the in-home system 6 detects whether a cable to be connected to the in-home communication device 9 is inserted in the second communication control unit 42 (S1201). If the cable is inserted, the service management unit 431 transmits a device address acquisition request from the second communication control unit 42 to the in-home communication device 9 (S1202).

The communication control unit 54 of the in-home communication device 9 acquires its own device address (S1203) and returns the result to the home gateway device 4 (S1204). The service management unit 431 of the home gateway device 4 registers the returned device address in the service information database 4311 (S1205).

Next, the connection control unit 432 of the home gateway device 4 reads the user information inputted by the user (S1206). Here, the user information is biometric information inputted from the biometric information input unit 992 or a password inputted from the in-home communication device 9 by the user and passed to the home gateway device 4. Subsequently, a check is made to decide whether the user information coincides with the information stored in the IC of the IC card inserted in the IC card read unit 991 (S1207). If they do not coincide, the process from step S1206 is repeated.

If the information coincide in step S1207, in the initialization process upon device start or the like, the connection control unit 432 of the home gateway device 4 transmits the address information of the home gateway device 4 (device address and URI), the address information (device address) of the in-home communication device 9 received in step S1105, and the device registration request information including the authentication information from the communication control unit 44 via the communication medium 8, the router device 3, and the communication medium 7 to the access management server device 2 (S1208).

The access management server device 2 firstly searches the authentication information management database for authentication information matched with the authentication information contained in the device registration request information from the home gateway device (S1209). As a result, if no authentication information is matched and the authentication fails, the access management server device 2 returns information indicating connection rejection to the home gateway device 4. The home gateway device 4 receives the connection rejection information and displays a message that the connection with the access management server device 2 has failed on the output unit, thereby terminating the device access start process.

On the other hand, if there exists authentication information matched with the authentication information contained in the device registration request information and the authentication is successful, the access management server device 2 registers the address information of the home gateway device 4 and the in-home communication device 9 contained in the device registration request information in the connection management database (S1210) and returns information indicating that the connection is successful to the home gateway device 4 (S1211). The connection control unit 432 of the home gateway device 4 receives the successful connection information and enters a state for waiting for data such as connection instruction information transmitted from the access management server device 2 (S1212). That is, the connection control unit 432 waits in the state for monitoring the data communication from the access management server device 2 and ready to operate the connection control unit 432 by the information contained in data upon reception of the data.

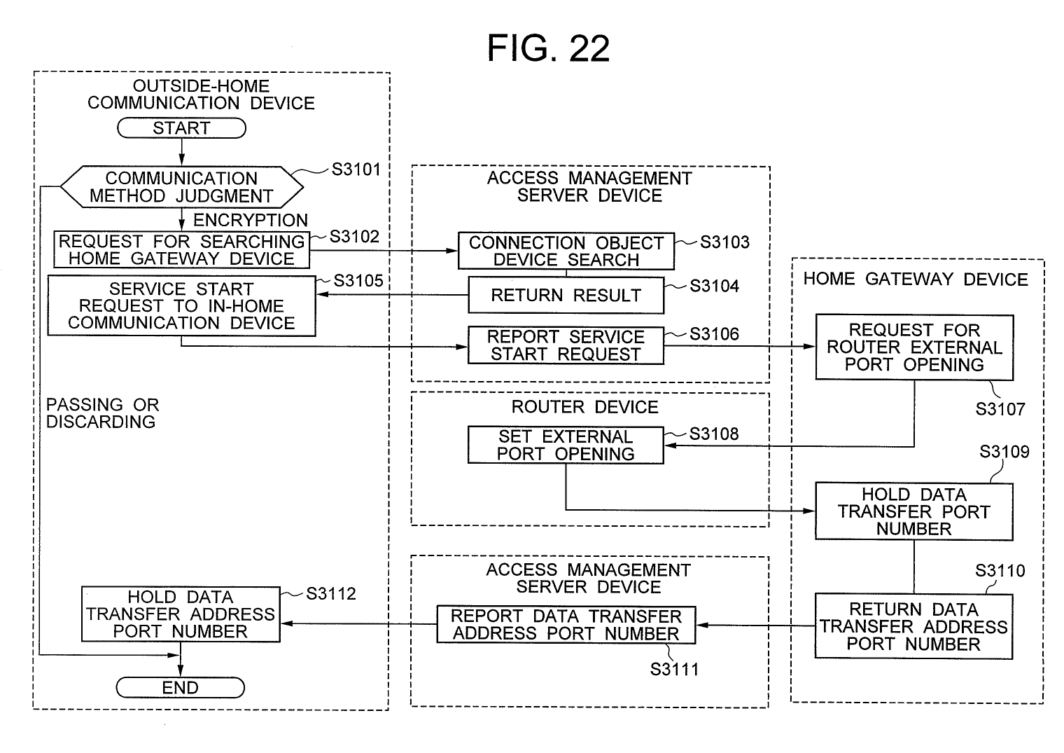

Next, FIG. 22 shows a flowchart of processes executed in the service execution start process (S3100).

When the service execution unit 11 of the outside-home communication device 1 starts linked service execution with the in-home communication device (communication start), the communication setting unit 121 judges the communication method (S3101). The communication setting unit 121 holds a connection policy database similar to that held by the home gateway device 4 and makes judgment according to the contents of connection policy database. If the judgment result is passing of discarding, the process is terminated. Upon start of the communication, the communication setting unit 121 may hook the communication data transmitted by the service execution unit 11 to the communication control unit 11 or the service execution unit 11 may explicitly call the communication setting unit 121.

If the judgment result in S3101 is encryption and no connection permission information in the communication exists in the communication setting unit 121, the connection control unit 132 transmits address information (device address) of the in-home communication device 9 together with the address information search request of the home gateway device 4 from the communication control unit 14 via the communication medium 7 to the access management server device 2 (S3102). It should be noted that if connection permission information in the communication exists in the communication setting unit 121, the process is terminated and the outside-home communication device 1 continuously executes the service data transfer process (S4100).

The access management server device 2 searches the connection management database for the address information of the home gateway device correlated with the address information of the in-home communication device 9 contained in the address information search request from the outside-home communication device 1 (S3103). As a result, if no address information is matched and the connection destination is unknown, the access management server 2 returns information indicating that the connection destination is unknown to the outside-home communication device 1. The connection control unit 132 receives the information indicating that the connection destination is unknown and displays a message that the connection destination with the access management server device 2 is unknown on the output unit, thereby terminating the service execution start process.

On the other hand, if there exists address information (URI) of the matched home gateway device, the address information is transmitted to the outside-home communication device 1 (S3104).

Next, the connection control unit 132 transmits the connection instruction information containing the address information (URI) from the communication control unit 14 to the home gateway device 4 via the communication medium 7, the router device 3, and the communication medium 8 (S3105).

The access management server device 2 transmits (transfers) the connection instruction information to the home gateway device 4 corresponding to the address information contained in the connection instruction information from the outside-home communication device 1 (S3106). In the home gateway device 4, the connection control unit 432 of the connection management unit 43 associates or correlates (releases) the external port of the router device 3 with the device address and the internal port of the home gateway device 4 and the connection control unit 432 transmits the conversion setting request information containing the conversion setting information via the communication medium 8 so that communication from the home gateway device 4 can reach the home gateway device 4 in the in-home system 6 (S3107). The conversion setting information used here includes the external port number of the router device 3, the internal port number correlated, and the device address of the home gateway device 4.

Moreover, the external port number and the internal port number used are not registered (not duplicated, matched information not existing) in the port number conversion information in the port information database 4331. The method for deciding the port number may be, for example, a method for selecting a number not duplicated in the ascending order in the valid range or a method for selecting a random number in the valid range. Moreover, if no limit exists on the router device 3 or the in-home communication device 5, it is preferable that the external port number be identical to the internal port number.

Next, in the router device 3, the port conversion control unit receives the conversion setting request information and adds a new port conversion setting to the port conversion unit of the router device 3 according to the external port number, the internal port number, and the device address contained in the conversion setting request information (S3108). If the port number setting of the router device 3 has bee used by another device, the steps S3107 to S3108 are repeated until the port conversion setting is successful.

Next, in the home gateway device 4, the connection control unit 432 registers the device address, the external port number, and the internal port number of the in-home communication device to be communicated, in the port information database 4331 (S3109) and returns the address information (device address and external port number of the router device 3) required for communication with the in-home communication device 9 and the connection permission information to the access management server device 2 (S3110). The access management server device 2 receives the connection permission information and transfers the connection permission information to the outside-home communication device 1 which has transmitted the connection instruction information (S3111).

In the outside-home communication device 1, the connection control unit 132 receives the connection permission information and reports the address information contained in the connection permission information to the communication setting unit 121 of the peer-to-peer communication unit 12 and the communication setting unit 121 holds the address information for the data transfer process (S3112), thereby terminating the process. At this moment, the outside-home communication device 1 can encrypt the communication data and transmit it to the in-home communication device 9 (via the home gateway device 4).

It should be noted that in the aforementioned service execution start process, it is possible to perform peer-to-peer communication while assuring security by sharing encrypted information for the peer-to-peer communication (encrypted communication) between the outside-home communication device 1 and the home gateway device 4. The encrypted information indicates a policy in the encrypted communication between devices including an encryption algorithm, an encryption key length, an encryption key, and the like. Moreover, the acquisition procedure of the encrypted information in the service execution start process may be a method for reporting by the access management server device 2, a method for reporting from the outside-home communication device 1 to the home gateway 4, or a method for reporting from the home gateway device 4 to the outside-home communication device 1.

In the method of reporting the encrypted information by the access management server device 2, the access management server device 2 decides the encrypted information and reports it to the home gateway device 4 by including the encrypted information in the connection instruction information to be transmitted to the home gateway 4 in step S3106 while reporting it to the outside-home communication device 1 by including the encrypted information in the connection permission information to be transmitted to the outside-home communication device in step S3111. In this case, the communication setting unit 411 enters a state for waiting for communication from the outside-home communication device 1 and sets encrypted information in the encrypted communication unit 412.

Moreover, in the outside-home communication device 1, the communication setting unit 121 holds the address information contained in the connection permission information and sets the encrypted information contained in the connection permission information in the encrypted communication unit 122 in step S3112.

Moreover, in this method, in order to decide encrypted information applicable to each of devices, the access management server device 2 requires a database for registering the contents of the encryption function of each of the devices such as an applicable encryption algorithm. The timing for registering the encryption function may be, for example, the device access start process (S1100). In this case, the device encryption function contents are included in the device registration request information transmitted by the home gateway device 4 in step S1106 and the access management server device 2 registers the encryption function contents upon device registration in step S1108.

Moreover, in the method for reporting the encrypted information from the outside-home communication device 1 to the home gateway device 4, the outside-home communication device 1 decides the encrypted information. In step S3105, the outside-home communication device 1 includes the encrypted information in the connection instruction information to be transmitted to the access management server device to report the encrypted information to the home gateway 4 and the communication setting unit 411 enters the state for waiting for communication from the outside-home communication device 1 and sets the encrypted information in the encrypted communication unit 412.

Moreover, in the method for reporting the encrypted information from the home gateway device 4 to the outside-home communication device 1, the home gateway device 4 decides the encrypted information. In step S3110, the home gateway device 4 includes the encrypted information in the connection permission information to be transmitted to the access management server device 2, thereby reporting the encrypted information to the outside-home communication device 1.

In this case, in the outside-home communication device 1, in step S3112, the communication setting unit 121 holds the address information contained in the connection permission information and sets the encrypted information contained in the connection permission information in the encrypted communication unit 122. Moreover, in step S3105, the outside-home communication device 1 includes the encryption function contents in the connection instruction information to be transmitted to the access management server device 2 so as to acquire the encryption function contents of the outside-home communication device 1 for deciding the encrypted information applicable to the outside-home communication device 1.

It should be noted that in the aforementioned service execution start process, by performing a setting that the router device 3 reject a connection request other than the device address of the outside-home communication device 1 as the connection source upon port conversion setting of the router device 3 (filtering setting), it is possible to prevent an unauthorized connection to the home gateway 4 and the in-home communication device 9. In this case, in step S3105, the outside-home communication device 1 includes the address information of the outside-home communication device 1 in the connection instruction information to be transmitted to the access management server device 2 so as to report the device address of the outside-home communication device 1 to the home gateway device 4; and in step S3107, the home gateway device 4 includes the device address in the conversion setting request information to be transmitted to the router device 3, so that in step S3108, the router device 3 can perform filtering setting with the device address in addition to the port conversion setting.

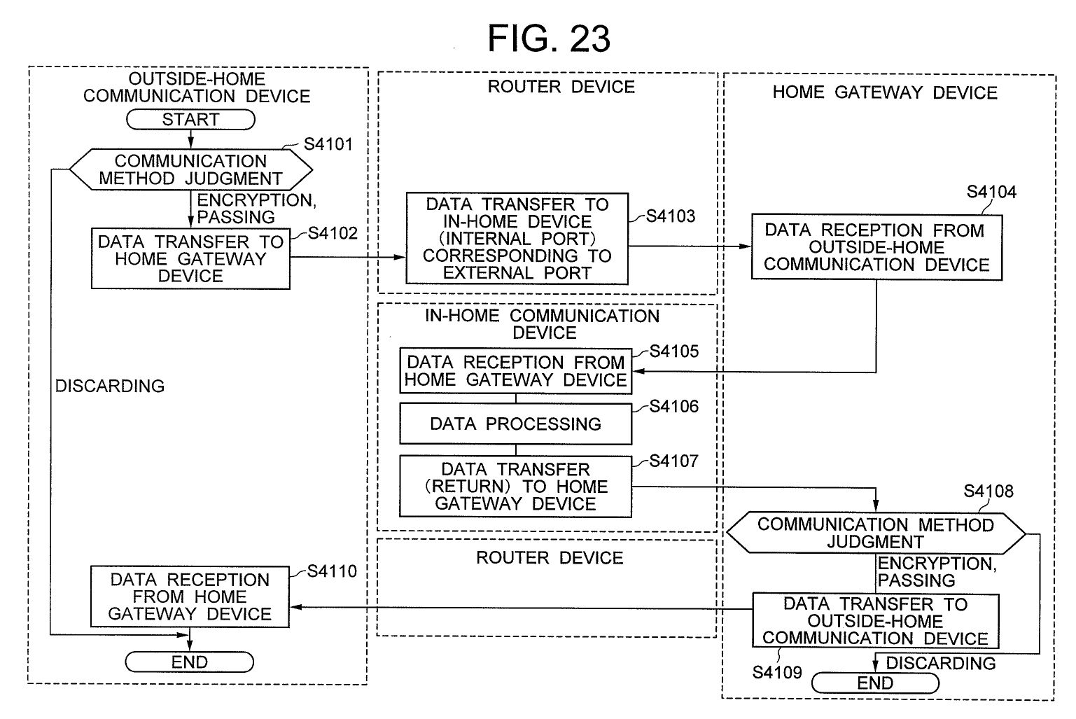

FIG. 23 is a flowchart of processes executed in the service data transfer process (S4100).

In order to perform data transfer in linked service execution with the in-home communication device 9, the service execution unit 11 of the outside-home communication device 1 transmits transfer data to the communication control unit 14 and the communication setting unit 121 hooks the transfer data. Moreover, the service execution unit 11 may explicitly transmits the transmission data to the communication setting unit 121.

Firstly, the communication setting unit judges the communication method (S4101). The communication setting unit 121 holds a connection policy database similar to the one held by the home gateway device 4 and makes judgment according to the contents of the connection policy database. If the judgment result is discarding, the process is terminated.

If the judgment result is encryption in S4101 and the connection permission information exists for the communication in the communication setting unit 121, the transfer data is encrypted by the encrypted communication unit 122 according to the encryption information contained in the connection permission information before being transmitted to the home gateway device 4 (S4102). It should be noted that if the connection permission information is absent, the service execution start process (S3100) is executed.

If the judgment result is passing in S4101, the transfer data is directly transmitted to the home gateway device 4 as it is.

The transfer data is actually received by the router device 3. The port conversion unit acquires the corresponding device address and the internal port number from the external port number and transmits (relays) the transfer data to the home gateway device 4 as the corresponding device (S4103).

Next, in the home gateway device 4, the communication setting unit 411 set to the data wait state in the service execution start process receives the transfer data (S4104). Here, the communication setting unit 411 decrypts the transfer data according to the encrypted information set in the service execution start process before transmitting it to the corresponding in-home communication device 9 via the second communication control unit 42 according to the contents of the port information database 4331 in step S3109.

Next, the service execution unit 51 receives the transfer data (S4105) and executes a linked service process according to the transfer data (S4106). If data should be returned to the outside-home communication device 1 as a result of the process in the service execution unit 51, the service execution unit 51 transmits the transfer data to the home gateway device 4 via the communication control unit 54 (S4107).

In the home gateway device 4, the communication setting unit 411 performs judgment of the communication method (S4108). The communication setting unit 411 makes judgment according to the contents of the connection policy database 4121. If the judgment result is passing or discarding, the process is terminated.

If the judgment result is encryption in S4108 and the communication setting unit has the connection permission information for the communication, the transfer data is encrypted by the encrypted communication unit 412 according to the encrypted information contained in the connection permission information before transmitted to the outside-home communication device 1 (S4109). It should be noted that if the connection permission information is absent, the service execution start process (S3100) is executed.

If the judgment result in S4108 is passing, the transfer data is directly transmitted to the home gateway 4 as it is.

In the outside-home communication device 1, the communication setting unit 121 receives the transfer data (S4110). The communication setting unit 121 decrypts the transfer data by the encrypted communication unit 122 according to the encryption information set in the service execution start process before transmitting it to the service execution unit 21. The service execution unit 21 executes a linked service process according to the transfer data. If further data transfer is required, the process of steps S4101 to S4110 are repeated.

It should be noted that in the above-given explanation, in the service execution start process (S3100), data is encrypted or decrypted according to the encryption information set in the encrypted communication unit 122 or in the encrypted communication unit 522 before transmitting the data. However, it is also possible to add a process such as encryption information exchange upon data transfer between the devices so as to set new encryption information. That is, the encryption information in the service execution start process is used in the encrypted communication for encryption information exchange in the service data transfer process.

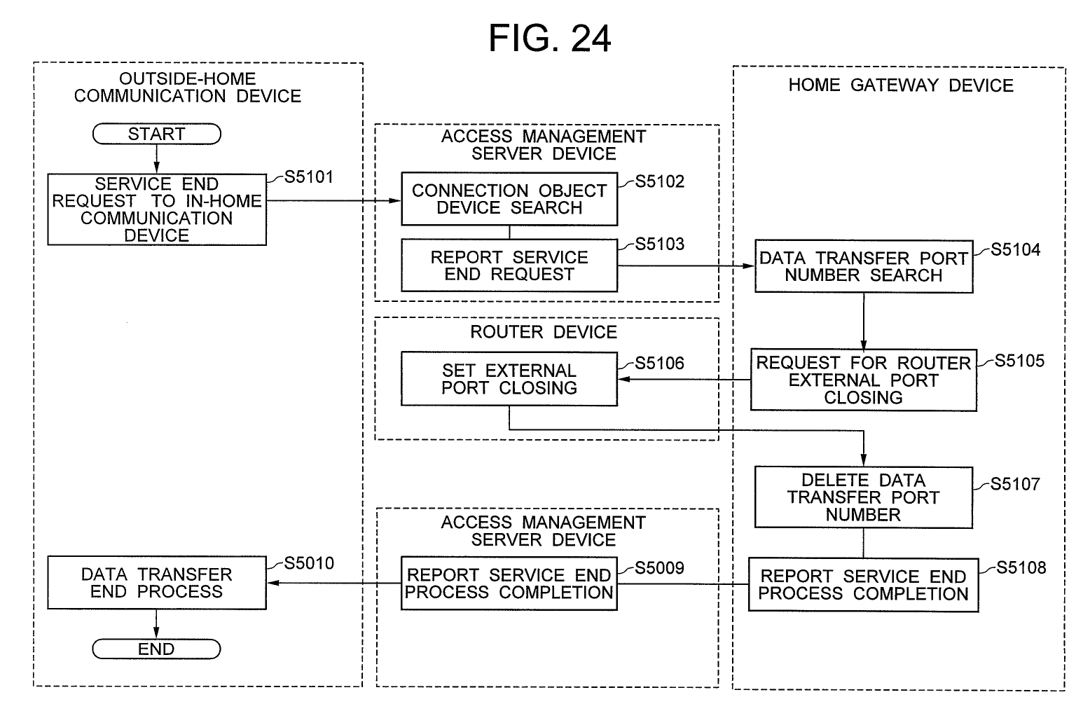

FIG. 24 is a flowchart of processes executed in the service execution end process (S5100).

In order to terminate the linked service execution with the in-home communication device 9, the service execution unit 11 of the outside-home communication device 1 transmits connection end instruction information containing the address information on the in-home communication device 9 from the communication control unit 14 to the home gateway device 4 via the communication medium 7, the router device 3, and the communication medium 8 (S5101). The access management server device 2 firstly searches the connection management database for the address information matched with the address information contained in the connection instruction information from the outside-home communication device 1 (S5102).

As a result, if no address information is matched and the connection destination is unknown, the access management server device 2 returns the information indicating that the connection destination is unknown to the outside-home communication device 1. The connection control unit 132 of the outside-home communication device 1 receives the information indicating that the connection destination is unknown and displays a message that the connection destination with the access management server device 2 is unknown on the output unit, thereby terminating the service execution end process.

On the other hand, if there exists address information matched with the address information contained in the connection end instruction information, the connection end instruction information is transmitted (transferred) to the home gateway device 4 corresponding to the address information (S5103). In the home gateway device 4, the connection control unit 432 of the connection management unit 43 receives the connection end instruction information and searches the service information database 4311 for the address information (the device address of the in-home communication device 9) contained in the connection end instruction information.

As a result if no address information is present and the connection is rejected, the connection control unit 432 returns the information indicating the connection rejection to the access management server device 2. The access management server device 2 receives the connection rejection information and transmits (transfers) the information indicating the connection rejection to the outside-home communication device 1 which has transmitted the connection end instruction information. The connection control unit 132 of the outside-home communication device 1 receives the connection rejection information and displays a message indicating that the connection with the in-home communication device 9 upon service execution start has failed on the output unit, thereby terminating the service execution end process.

On the other hand, if there exists the address information contained in the connection end instruction information, the connection control unit 432 of the home gateway device 4 acquires the internal port number of the port conversion setting of the router device 3 corresponding to the address information from the port information database 4331. The connection control unit 432 releases the correlation between the external port number of the router device 3 and the device address and the internal port number of the in-home communication device 9 and transmits a conversion setting request containing the conversion release information via the communication medium 8 in order to terminate reach of the communication from the outside-home communication device 1 into the in-home system 6 (S5105).

The conversion release information used here contains the external port number and the internal port number of the router device 3. Next, in the router device 3, the port conversion control unit receives the conversion setting request information and deletes the port conversion setting from the port conversion unit of the router device 3 according to the external port number and the internal port number contained in the conversion setting request information (S5106).

Next, in the home gateway device 4, the connection control unit 432 deletes the external port number, the internal port number, and the device address which is associated with the port conversion setting which has been deleted by the connection control unit 432, from the port information database 4331 (S5107) and returns the connection end information to the access management server 2 (S5108). The access management server device 2 receives the connection end information and transfers the connection end information to the outside-home communication device 1 which has transmitted the connection release instruction information (S5109). The connection control unit 132 of the outside-home communication device 1 receives the connection end information and reports the end of data communication with the in-home communication device 5 to the communication setting unit 121 of the peer-to-peer communication unit 12. The communication setting unit 121 terminates the data transfer (S5110).

It should be noted that the service execution end process (S5100) may be started not only by explicit transmission of the connection end instruction information by the service execution unit 1 of the outside-home communication device 1 but also by transmission of the connection end instruction information by the connection control unit 432 of the outside-home communication device 1 if no communication has been performed between the outside-home communication device 1 and the in-home communication device 9 for a predetermined time.

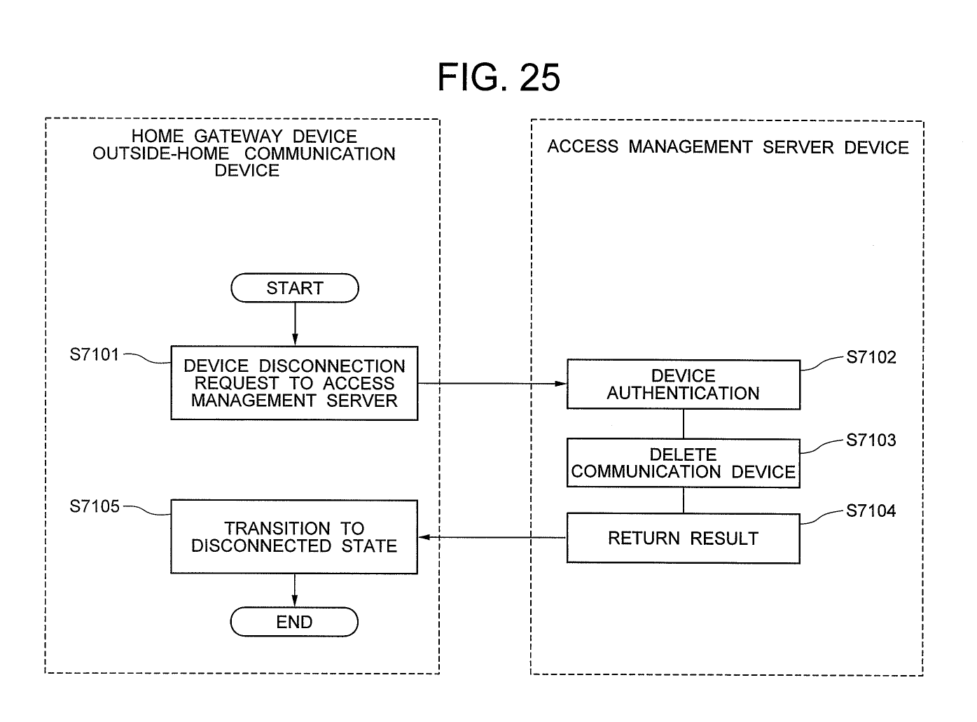

FIG. 25 is a flowchart of processes executed in the device access end process (S7100).

In the end process upon device termination, the connection control unit 432 of the home gateway device 4 contained in the in-home system 6 transmits the device delete request information including the authentication information from the communication control unit 44 via the communication medium 8, the router device 3, and the communication medium 7 to the access management server device 2 (S7101). The access management server device 2 firstly searches the authentication information management database for the authentication information matched with the authentication information contained in the device delete request information from the home gateway device 4, i.e., performs an authentication process (S7102). As a result, if no authentication information is matched and the authentication has failed, the access management server device 2 returns information indicating that the connection is rejected to the home gateway device 4. The home gateway device 4 receives the connection rejection information and displays a message indicating that the connection with the access management server device 2 has failed on the output unit, thereby terminating the device access end process.

On the other hand, if there exists authentication information matched with the authentication information contained in the device delete request information and the authentication is successful, the address information corresponding to the home gateway device 4 is deleted from the connection management database (S7103) and information indicating that deletion is successful is returned to the home gateway device 4 (S7140). The connection control unit 432 of the home gateway device 4 receives the information on the successful deletion and then releases the state for waiting for data from the access management server device 2 (S7105). That is, monitoring of the data communication from the access management server device 2 is terminated.

It should be noted that the device access end process (S7100) is executed when the home gateway device 4 is terminated or when the connection between the home gateway device 4 and the in-home communication device 9 is cut off (the cable inserted into the second communication control device 42 is pulled out). In this case, the service execution end process (S5100) is performed in advance in all the services where the service data transfer process (S4100) is executed.

As has been described above, the communication data to the in-home communication device 9 always passes through the home gateway device 4. In the home gateway device 4, data other than the encrypted data as a result of execution of the service execution start process (S3100) judges the communication method of the communication data according to the content of the connection policy database 4121, thereby preventing an unauthorized access to the in-home communication device 9. That is, the inter-device communication for which encryption is set as an action in the connection policy database 4121 (communication between the outside-home communication device 1 and the in-home communication device 9) always should execute the service execution start process (S3100) and accordingly, only the outside-home communication device 1 which has been authenticated successfully can communicate with the in-home communication device 9. If communication data is not encrypted in the communication for which encryption is set as an action, the communication data is discarded.

This enables a highly safe access from outside-home to an in-home device having no encryption ability, i.e., having a low processing ability.

In the aforementioned example, the outside-home communication device 1 is a single device (outside-home device). However, the function and the database configuration of the outside-home communication device 1 may be, for example, installed in a server device of a service providing company. Moreover, even when the outside-home communication device 1 is another in-home system having the same configuration as the in-home system 6, operation can be performed by the same procedure.

Moreover, in the aforementioned example, communication is performed to the in-home communication device existing in the in-home system. However, even when the in-home system is replaced by an in-company LAN system, operation can be performed by the same procedure. In this case, the in-home communication device 9 corresponds to a PC, a printer, a job server, and the like. For example, when the outside-home communication device 1 is a mobile PC and the in-home communication device 9 is a job server (conference room reservation system server), it is possible to safely reserve a conference room by using the mobile PC from external to the company (corresponding to “outside-home”).

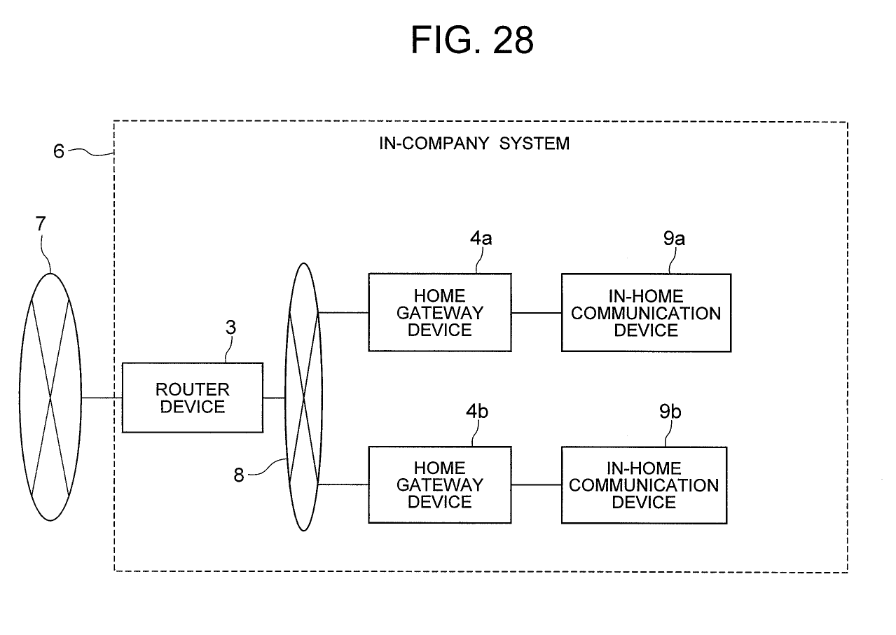

Moreover, in another example, in the in-company LAN system as shown in FIG. 28, the in-home communication device 9a is a PC, and the in-home communication device 9b is a printer. The in-home communication devices are respectively connected to the home gateway devices 4a, 4b. When performing printing in the printer (9b) from the PC (9a), the present embodiment may be employed. In this case, in the home gateway device 4a, it is necessary to perform user authentication and encrypted communication is performed with the home gateway device 4b. Accordingly, even within the same in-company LAN, it is possible to perform a highly safe communication.

Furthermore, even when the outside-home communication device 1 is another in-company LAN system having the same configuration as the aforementioned in-company LAN system, operation can be performed by the same procedure. In this case, it is possible to perform a highly safe communication between a plurality of locations of the company.

Moreover, in the case of the configuration shown in FIG. 16, the process of controlling the router device 3 by the home gateway device 4 (steps S3107, step S3109, step S5105, step S5107, etc.) may be realized not only by the communication protocol such as UPnP but also by the internal data transfer. Accordingly, it becomes possible to omit the router control unit 433 of the connection management unit 43 and the port information database 4331.

The present embodiment may be applied to a system for controlling home electric devices and/or home facility devices connected to a home network by using an outside-home device. The present embodiment may be used, for example in a large-capacity data communication service for controlling an in-home DVD/HDD recorder from outside-home and downloading the content accumulated in it to an outside-home device or energy-saving, home security, and remote device control service for controlling home facility devices such as an in-home air conditioner, a lamp, and an electric key from outside-home. Moreover, the present embodiment may be used in a remote office service for accessing an in-company Web server or the like in the in-company system from out of the company. In order to realize such services, the present embodiment prevents an unauthorized access and preferably improves the safety.

The present invention has been explained through an embodiment. However, as is clear to those skilled in the art, the present invention is not limited to the embodiment and can be modified and corrected within the spirit of the present invention and the scope of attached claims.

1. An adapter device connected to a network for encrypted communication, the apparatus comprising:
a memory for storing connection policy information for a first communication device connected to the network and a second communication device connected to the adapter device;
a communication controller for judging a method of communication from the first communication device to the second communication device by using the connection policy information; and
an encrypted communication unit for discarding communication data received from the first communication device if the communication controller makes a judgment of encrypted communication and the communication data is not encrypted.

2. The adapter device as claimed in claim 1, wherein
an access management device connected to the network includes a connection controller for registering the adapter device; and
the connection controller detects a connection with the second communication device and registers it in the access management device.

3. The adapter device as claimed in claim 2, wherein
the adapter device includes a user information read unit; and
the connection controller compares user information transmitted from the second communication device with user information read from the user information read unit and registers the information if they coincide.

4. The adapter device as claimed in claim 2, wherein
the connection controller releases the registration from the access management device upon detection of that the connection with the second communication device is cut off.

5. An adapter device connected to a network for performing encrypted communication, the adapter device comprising:
a memory for storing connection policy information for a first communication device connected to the network and a second communication device connected to the adapter device;
a communication controller for judging a method of communication from the second communication device to the first communication device by using the connection policy information; and
an encrypted communication unit for encrypting communication data received from the second communication device and transmitting it to the first communication device if the communication controller makes a judgment of encrypted communication.

6. The adapter device as claimed in claim 5, wherein
an access management device connected to the network includes a connection controller for registering the adapter device; and
the connection controller detects a connection with the second communication device and registers it in the access management device.

7. The adapter device as claimed in claim 6, wherein
the adapter device includes a user information read unit; and
the connection controller compares user information transmitted from the second communication device with user information read from the user information read unit and registers the information if they coincide.

8. The adapter device as claimed in claim 6, wherein
the connection controller releases the registration from the access management device upon detection of that the connection with the second communication device is cut off.

9. An encrypted communication method comprising steps of:
storing connection policy information for a first communication device connected to the network and a second communication device connected to the adapter device;
judging a method of communication from the first communication device to the second communication device by using the connection policy information; and
discarding communication data received from the first communication device if a judgment of encrypted communication is made and the transmission data is not encrypted.

10. The encrypted communication method as claimed in claim 9, wherein
when the communication controller makes a judgment of encrypted communication, the communication data received from the second communication device is encrypted before transmitted to the first communication device.

11. The encrypted communication method as claimed in claim 9, wherein
after connection with the second communication is detected, the adapter device is registered in the access management device.

12. The encrypted communication method as claimed in claim 11, wherein
user information received from the second communication device is compared to the user information read by the adapter device, and if the information coincide, it is registered in the access management device.

13. The encrypted communication method as claimed in claim 11, wherein
upon detection of that the connection with the second communication device is cut off, the registration is released from the access management device.
